(19) United States
(12) Patent Application Publication
(10) Pub. No.: US 2015/0339446 A1
(43) Pub. Date: Nov. 26, 2015

(54) DASHBOARD INTERFACE, SYSTEM AND ENVIRONMENT

(71) Applicant: AON Global Operations Limited (Singapore Branch) (Reg. T12FC0122F), Singapore (SG)

(72) Inventors: Kenneth L. Sperling, Orange, CT (US); Karen F. Frost, Lakemoor, IL (US); Steven W. Clark, Grayslake, IL (US); David Mallett, Colchester, CT (US); Tim Maroz, Melbourne, FL (US); David T. Petta, Papillion, NE (US); Justin M. Kindy, Greenwood Village, CO (US); Timothy N. Nimmer, Castle Rock, CO (US); Jordan l. Simmermaker, Mundelein, IL (US)

(73) Assignee: AON Global Operations Limited (Singapore Branch) (Reg. T12FC0122F), Singapore (SG)

(21) Appl. No.: 14/635,956

(22) Filed: Mar. 2, 2015

Related U.S. Application Data
(63) Continuation-in-part of application No. 14/283,806, filed on May 21, 2014.

(51) Int. Cl. G06F 19/00

(52) U.S. Cl. CPC G06F 19/328

(57) ABSTRACT

A dashboard interface, system and environment connects industry participants to entities and/or individuals to support the selection and management of products and associated activities. Dashboard interfaces presented to the industry participants, entities, and individuals provide up-to-date information regarding products as well as comparison information.

### RELATED APPLICATION

The present application is a continuation-in-part of and claim priority to U.S. patent application Ser. No. 14/283,806 filed May 21, 2014, the content of which is hereby incorporated by reference in its entirety. The present application is related to U.S. patent application Ser. No. 13/231,601 filed Sep. 13, 2011.

### SUMMARY OF ILLUSTRATIVE EMBODIMENTS

A dashboard interface, system and environment, as described herein, connects industry participants to entities and/or individuals to support the selection and management of products and associated activities. Dashboard interfaces presented to the industry participants, entities and individuals provide the viewer with up-to-date information regarding their products as well as comparison information. For example, an individual user dashboard presents a user with product information, product ratings information, and individual user assessments of individual metrics and a comparison of the individual metrics to demographic metrics. An entity dashboard presents much of the same information as the individual user dashboard, but in aggregate form. For example, the entity dashboard presents information on products purchased by or subscribed to by individual users associated with the entity, product ratings, and aggregate metric data. Additionally, the entity dashboard presents comparisons between the entity and selected additional entities (e.g., competitors or peers of the entity), such as product adoption comparisons and metric comparisons. An industry participant dashboard, for example, presents an industry participant with product information, adoption information (e.g., product obtainment, declined offers, and offers receiving no response), activity information related to the industry participant's products, user metrics and market demographic metrics, and comparisons of such metrics to metrics of competitors or peers. The metrics can be indexed by geographical regions, sectors, and/or demographic classifications of the individual users.

### BRIEF DESCRIPTION OF THE FIGURES

FIG. 1 is a screen shot of an example individual user dashboard interface for accessing individual user information via a dashboard system;

FIG. 2 is a screen shot of an example entity dashboard user interface for accessing entity information via a dashboard system;

FIG. 3 is a screen shot of an example dashboard interface for accessing information about a dashboard system and environment;

FIGS. 4A though 4C illustrate screen Shots of example industry participant dashboard interfaces for accessing information via a dashboard system;

FIGS. 5A and 5B are block diagrams of example environments for managing the provision of products between industry participants and individual users;

FIGS. 6A and 6B illustrate a swim lane diagram of an example method for porting a product established by an individual user via a prior entity to a present entity;

FIGS. 7A and 7B illustrate a flow chart of an example method for presenting a potential individual user with product information based in part on ratings data;

FIG. 8 is a block diagram of an example environment for personalizing the dashboard system experience for both entities and individual users; and

FIG. 9 is a block diagram of an example computing system.

### DETAILED DESCRIPTION OF ILLUSTRATIVE EMBODIMENTS

In some implementations, users (industry participants, entities, individual users, and dashboard system managers) interact with a system and environment via graphical user interface dashboards. Each dashboard includes a number of controls configured, upon selection, to present the user with information relevant to the type of user. The controls presented to a particular user may be configurable based upon a user profile. For example, an individual user may select various features (widgets, controls, and/or other information displays) to include within a personalized dashboard. In another example, features provided within the dashboard may be designated in part upon a user authorization level. For example, a human resources representative employed by an entity may have access to a limited view of metrics, while a CEO or board member may have unlimited access to metrics.

The dashboard system and environment, in some implementations, increases cost transparency by allowing individuals to compare the costs and benefits of various products offered either directly by industry participants or via entity-selected offerings. For example, an employer entity may select benefits offerings from an insurance plan carrier industry participant. In another example, an employer may interact with the dashboard environment as both an entity participant and as an industry participant that self-insures its claims and utilizes administrative services and/or network access offered by one or more insurance plan carrier industry participants. Entities may further enable constituent individual users (e.g., employees) to control costs by designating a defined contribution towards obtaining products. For example, the employee, through defined contribution, may have the option to select a plan within the defined contribution budget or a costlier plan requiring an employee contribution in addition to the employer-provided subsidy.

In some implementations, the dashboard system and environment further enhances the product selection experience for entities and/or individual users by allowing entities and/or individual users to rate the industry participants and the products offered through the system. The dashboard system and environment may include ratings information (e.g., in product comparison user interfaces) to allow entities and/or individual users to select those industry participants or products best suited to their needs, including those recognized for excellence by present owners or subscribers, at the individual users and/or entity level. In addition to ratings, the dashboard exchange system and environment may collect reviews submitted by entities and/or individual users. To best address the needs of a variety of entities and/or individual users, the dashboard system and environment may filter ratings or reviews to highlight those provided by entities/individual users similar to the reviewing entity/individual user. For example, the dashboard system and environment may filter by demographic and/or medical history information to identify individual users most similar to a current individual.

Rather than selecting a new product, in some implementations, the dashboard system and environment provides an individual user with the opportunity to port a current product from a former entity to a present entity. In this manner, for example, the individual user can maintain present insurance coverage during a career change.

In some implementations, the dashboard system and environment communicates with a third party medical history record repository to access medical history records on behalf of individual user. With individual user authorization, for example, the dashboard system and environment retrieves medical history records and combines the medical history record information with claims information, demographics information, and other information maintained by the dashboard system and environment. Through an individual user dashboard, for example, the individual user may review combined health data. Furthermore, the dashboard system and environment may analyze the medical history records to present value-added statistical information to the individual user, such as tracking health information (e.g., weight, cholesterol levels, blood pressure, etc.) graphically over time and recommending changes in behavior to mitigate identified areas of increased risk. In another example, the dashboard system may promote or recommend one or more products suited the individual's needs based upon tracked health information.

The dashboard system and environment, in some implementations, calculates statistical information regarding the various users (industry participants, entities, and/or individual users) involved in the dashboard system. For example, the dashboard system and environment may derive pricing statistics, cost statistics, and/or efficiency statistics regarding the various industry participants. In another example, the dashboard system and environment may track site usage of a web site, web portal, or network-enabled dashboard system to identify site usage statistics. In this manner, the dashboard system and environment may make improvements to the entity interface, industry participant interface, and/or individual user interface to increase value for the users involved in the dashboard system. In a third example, the dashboard system and environment may analyze claims data and/or prescription data to monitor usage of various plan features and/or to monitor premium payouts relative to plan subsidies paid.

In some implementations, the dashboard system and environment connects industry participants providing voluntary benefits products with entities (to enhance benefits offerings) and/or individual users (to round out household coverage based upon individual needs). The voluntary benefits products, for example, may include dental insurance, vision insurance, additional life/disability insurance, and/or pet insurance. The system may collect ratings, reviews, and/or statistics regarding the voluntary products in a similar manner as to the conventional health and medical plans.

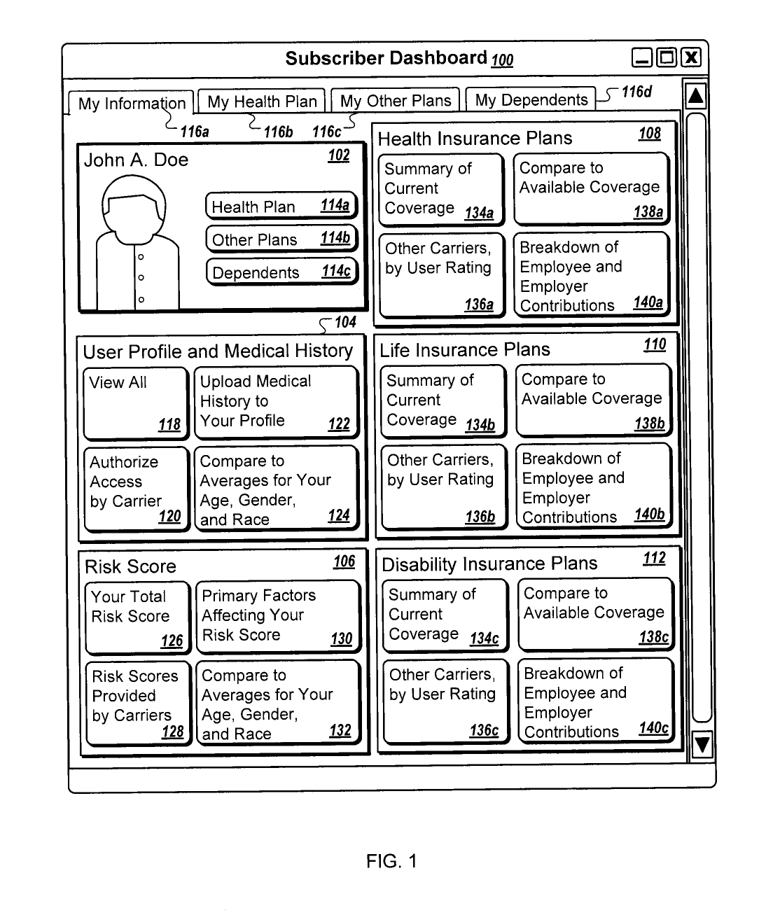

Beginning with the individual users, FIG. 1 is a screen shot of an example individual user dashboard 100 for accessing individual user information via a dashboard system. The dashboard 100 is part of a web site, web portal, personal computer application, or mobile device application configured to allow the individual user to interface with the dashboard system and environment. As illustrated, individual user “John A. Doe” is connected to the dashboard 100.

In a welcome pane 102, individual user Doe is presented with three navigation controls 114, correlating to three additional tabs 116 at the top of the dashboard 100. A first navigation control 114a, when selected, presents individual user Doe with detailed information regarding his health plan within a “my health plan” tab 116b. A second navigation control 114b, when selected, presents individual user Doe with detailed information regarding other plans subscribed to by individual user Doe (e.g., life insurance, disability insurance, etc.) within a “my other plans” tab 116c. A third navigation control 114c, when selected, presents individual user Doe with information regarding his dependents within a “my dependents” tab 116d.

In a present “my information” tab 116a, the dashboard 100 provides a number of selectable controls to individual user Doe, organized within a series of information panes 104, 106, 108, 110, and 112. In the first information pane 104, the dashboard 100 provides information regarding individual user Doe's user profile and medical history. In some implementations, a “view all” control 118, when selected, presents individual user Doe with personal information, including profile information (e.g., name, address, phone number, email address, etc.) and demographic information (e.g., age or birth date, gender, race, etc.). The medical history information presented by the “view all” control 118, for example, may include information regarding claims filed via the dashboard system and environment. If individual user Doe uploaded external medical history records, the “view all” control 118 may provide individual user Doe with a comprehensive review of medical history records.

If individual user Doe wishes to link electronic medical records to the dashboard 100, in some implementations, individual user Doe selects an “upload medical history to your profile” control 122. The control 122, upon selection, may provide a connection between the dashboard system and a third party electronic medical record repository. Upon authorization and validation of individual user John Doe, for example, individual user Doe's electronic medical records (or a portion thereof) may be accessed via the dashboard system. In this manner, in some examples, the dashboard system can help individual user Doe to identify dates of recent doctor visits or determine when individual user Doe was last vaccinated for tetanus. With access to individual user Doe's medical history, the dashboard system may automatically populate prescription information, medical diagnoses, health conditions, and/or health metric data into individual user Doe's user profile. Furthermore, upon selection of the “view all” control 118, the dashboard system may now provide individual user Doe with the ability to track medical trends or behaviors such as increase in weight over time or decrease in blood pressure over time.

After linking electronic medical records to the dashboard system and environment, in some implementations, individual user Doe can choose to authorize access the medical history data by one or more industry participants (e.g., health and medical plan carriers, self-insured employer, etc.). By selecting an “authorize access by carrier” control 120, for example, individual user Doe may authorize the dashboard system to share medical history information with one or more industry participants, such as the carriers (and/or self-insured employer) associated with individual user Doe's health insurance plan (e.g., described in relation to information pane 108), life insurance plan (e.g., described in relation to information pane 110), and/or disability insurance plan (e.g., described in relation to information pane 112). The dashboard system, for example, may share individual user medical history, upon authorization, as de-identified data. In this manner, the industry participants may access information regarding individuals within the dashboard system and environment without raising privacy concerns. The de-identification process, for example, may be based upon governmental guidelines, such as the U.S. Health Insurance Portability and Accountability Act (HIPAA) guidelines of 1996.

In some implementations, individual user Doe may select a “compare to averages for your age, gender, and race” control 124 to view a comparison between information contained in the user profile and/or user medical records and baseline numbers of a demographically similar population. The baseline numbers, for example, may represent average and/or median values determined from data provided by other individual users of the dashboard system and environment. The baseline data, in another example, may include data provided by a government or medical affiliation source, such as information collected by the National Institute of Health. Upon selection of the “compare to averages for your age, gender, and race” control 124, for example, individual user Doe may be presented with graphical illustrations of where particular health metrics (e.g., weight, blood pressure, cholesterol level, etc.) land in relation to present norms and/or goal values. For example, individual user Doe may have a statistically average body mass index and a significantly lower than average blood pressure.

Turning to the risk score information pane 106, a “your total risk score” control 126, upon selection, presents individual user Doe with information regarding his insurance risk score. The risk score information, in some examples, may include the raw score as well as, optionally, individual factors contributing to the score. Alternatively, rather than presenting the information upon selection of the “your total risk score” control 126, the risk score pane 106 may present a total risk score value, while additional controls within the risk score pane 106 may present details underlying the composition of individual user Doe's total risk score.

In some implementations, individual user Doe selects a “primary factors affecting your risk score” control 130 to learn about the composition of the risk score. For example, a number of factors may contribute to a risk score computation model such as, in some examples, age, gender, race, geographic region, and medical or other claims history. The primary factors may include factors under the control of individual user Doe such as, in some examples, smoking status, weight, and/or blood pressure. The “primary factors affecting your risk score” control 130 may present the risk score factors to individual user Doe, upon selection, to encourage individual user Doe to make improvements in the total risk score. Furthermore, in some implementations, the dashboard 100 presents individual user Doe with recommendations for assistance in managing goals in reducing overall risk score, such as an invitation to join a smoking cessation program, an advertisement regarding a weight loss medication, or a reminder regarding a gym membership benefit feature of individual user Doe's medical plan.

Individual user Doe, in some implementations, selects a “compare to averages for your age, gender, and race” control 132 to compare his risk score to other individual users (or established baseline averages) among those with a similar demographic background. In this manner, individual user Doe may compare his relative risk to those sharing demographic information with him.

If individual user Doe has one or more dependents (e.g., spouse, partner, and/or children) subscribed to the health product plan, in some implementations, selection of the your total risk score control 126 provides information regarding risk scores applied to each member of individual user Doe's subscription. Similarly, individual user Doe's wife, partner, and/or children may be provided the opportunity to review average comparisons by selecting the “compare to averages for your age, gender, and race” control 132 as well as primary factors affecting each individual's risk score through selection of the “primary factors affecting your risk score” control 130. Furthermore, in some implementations, each of the controls may provide information regarding primary factors and averages based upon the unit as a whole (e.g., as compared to other married couples in their thirties, as compared to other parents of multiple grade school children, etc.).

In some implementations, individual user Doe selects a “risk scores provided by carriers” control 128 to identify risk score applied by one or more carriers (e.g., the carrier of Doe's health product plan, the carrier of individual user Doe's life insurance plan, etc.). The plan carriers, for example, may each use internal algorithms for determining risk score. Additionally, should individual user Doe have an out-of-network plan, such as a state exchange plan, federal exchange plan or other private or group coverage obtained outside of the exchange system and environment, selection of the risk scores provided by carriers control 128 may cause presentation of the risk score calculated by the out-of-network plan. The factors contributing to risk scores generated by plan carriers may or may not be known. For example, the plan carrier may optionally volunteer information regarding factors which contribute to risk score determinations.

The three remaining information panes 108, 110, and 112 share identical controls, each set of controls providing information related to the various health and medical plans subscribed to by individual user Doe. As such, the health product plan pane 108, the life insurance plan pane 110, and the disability insurance plan pane 112 are described in general as containing plan controls 134, 136, 138, and 140. However, the information presented will differ, upon selection of the plan controls 134, 136, 138, and 140, based upon the type of plan being reviewed by individual user Doe.

A “summary of current coverage” control 134, when selected, presents individual user Doe with summary information regarding his plan coverage. The summary information, in the example of a health product plan, may include co-pay information, network providers, deductible information, and other health plan features. Similarly, the summary information, in the example of a life insurance plan, may include term, rate, death benefit, accidental death benefit, and present value.

To compare the present coverage with other available plans, in some implementations, individual user Doe selects a “compare to available coverage” control 138. Upon selection of the “compare to available coverage” control 138a, the individual dashboard may present individual user Doe with information regarding other plans available through the dashboard system. In the example of disability insurance, the dashboard 100 may present a comparison of premiums and benefit values of similar products to individual user Doe's current disability insurance. In another example, upon selection of the “compare to available coverage” control 138b, individual user Doe may be provided with a browser interface to select one or more other available plans for comparison. If individual user Doe's employer has selected particular plans as employee options, the “compare to available coverage” control 138 may limit the plans available for individual user Doe's review to only those plans selected by the employer.

In some implementations, individual user Doe selects an “other carriers by user rating” control 136 to review plans offered by the highest rated industry participants within the dashboard system. The ratings, for example, may be based upon a sliding scale, number of stars, or other rating mechanism demonstrating a level of satisfaction a particular individual user or entity has with a particular industry participant or product. In one example, various aspects of a plan and/or plan carrier may be rated separately. For example, the ratings and health and medical product exchange system may maintain separate individual user customer service ratings, employer customer service ratings, individual user billing ratings, and employer billing ratings for each plan carrier. The health and medical product exchange system, in another example, may maintain separate provider network ratings, plan feature ratings, and economic value ratings associated with each health plan offered by a particular carrier. For example, upon selection of the “other carriers by user rating” control 136, the dashboard 100 may present individual user Doe with available plans (or alternate carriers) corresponding to the top three carriers by ratings submitted by individual users (and/or employers). If individual user Doe's employer has selected particular plans as employee options, the “other carriers by user rating” control 136 may limit the plans or carriers available for individual user Doe's review to only those plans selected by the employer.

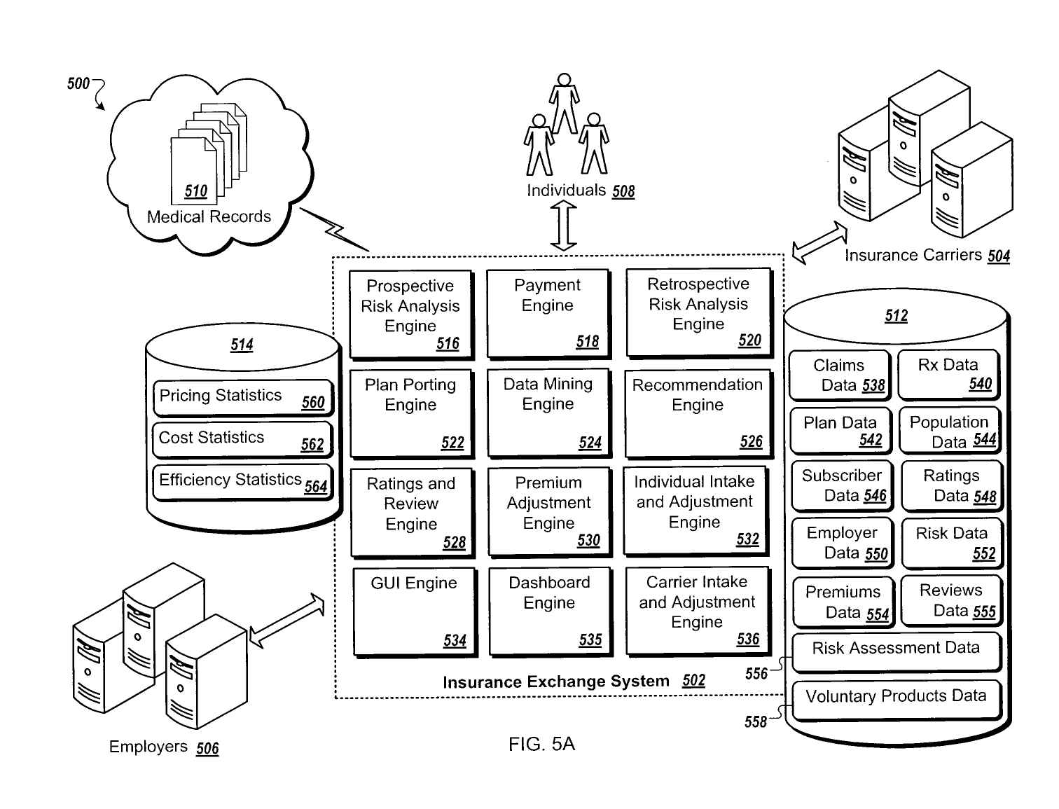

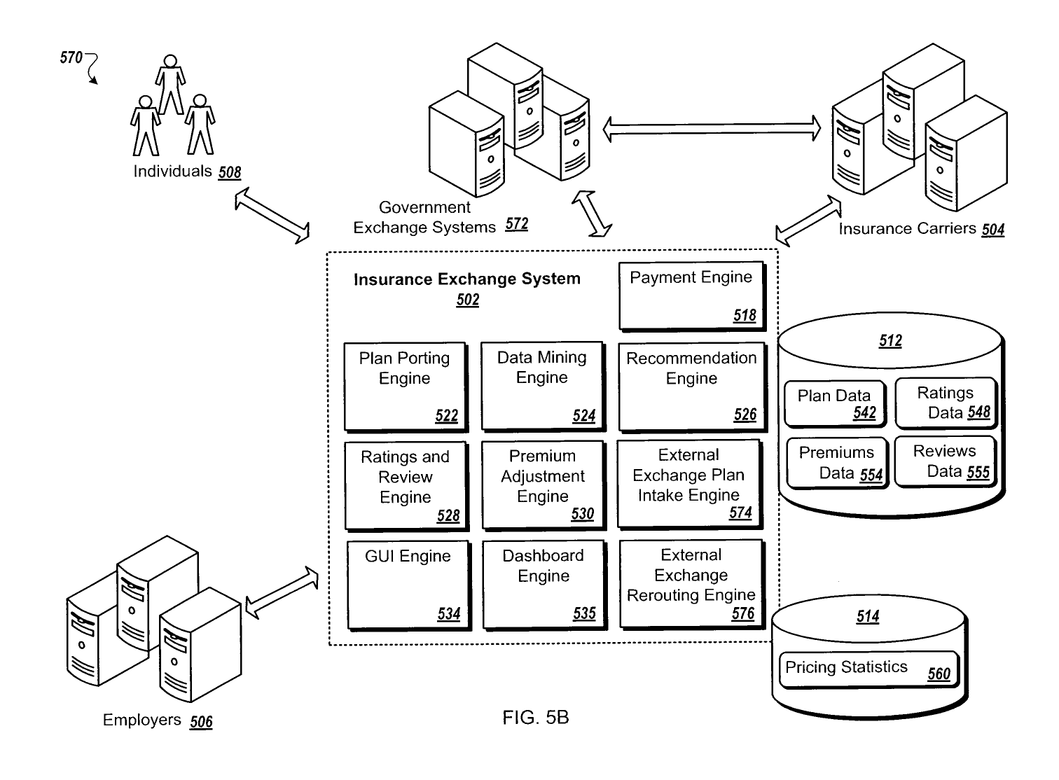

Instead of or in addition to presenting additional industry participants available through the dashboard system, selection of the “other carriers, by user rating” control 136a, in some implementations, presents individual user Doe with information regarding plans or carriers available through one or more government-run health and medical product exchange systems, such as a federal health care exchange or a state health care exchange. Carriers, for example, may sign up with the dashboard system to allow the dashboard system to act as the state exchange broker or federal exchange broker. Interaction between the dashboard system and state and/or federal product exchanges is described in greater detail in relation to FIG. 5B.

In some implementations, if individual user Doe is an individual participating independently in the dashboard system and environment (e.g., as opposed to being associated with a particular entity), or if individual user Doe has been provided an employer contribution for selection of available products, the “other carriers by user rating” control 136 provides individual user Doe the opportunity to request a quote from an alternate industry participant. In this manner, individual user Doe can shop around for quotes. Conversely, since individual user Doe's demographic information and risk score is already known by the dashboard system, a customized quote may be automatically provided in relation to the additional industry participants.

A “breakdown of employee and employer contributions” control 140, presents, upon selection by individual user Doe, information regarding the employer payment towards the plan and the remaining premium covered by individual user Doe. If the employer has provided a defined contribution, the “breakdown of employee and employer contributions” control 140 may compare the defined contribution to the actual cost of the plan.

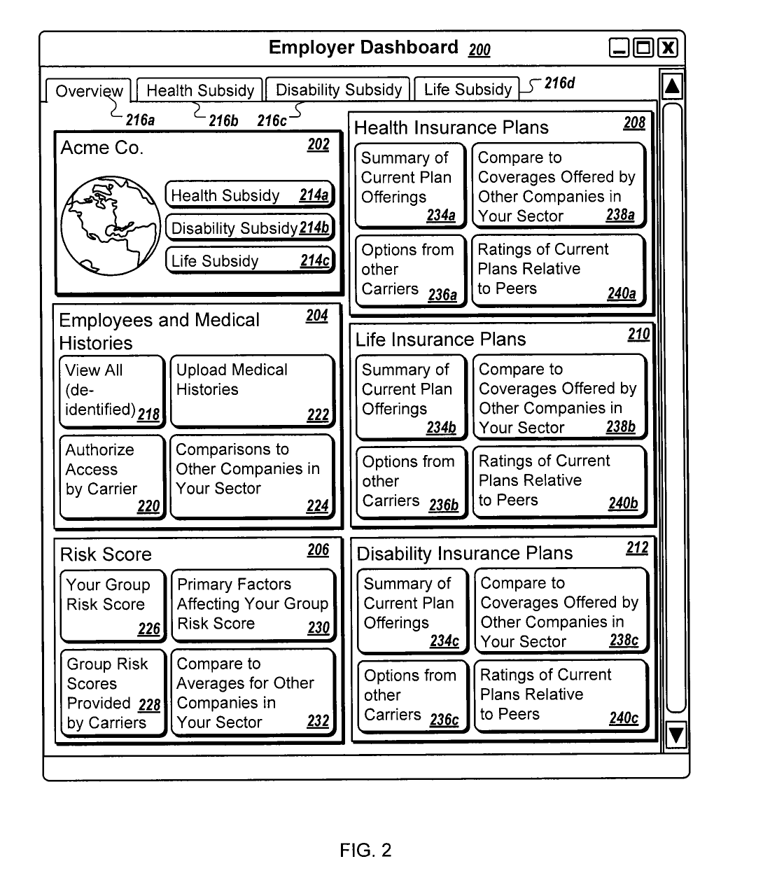

FIG. 2 is a screen shot of an example entity dashboard user interface 200 for accessing entity information via a dashboard system. The dashboard 200 is part of a web site, web portal, personal computer application, or mobile device application configured to allow the entity (e.g., employer benefits manager, human resource personnel, board member, or other corporate official) to interface with the dashboard system and environment. As illustrated, employer “Acme Co.” is connected to the dashboard 200.

In a welcome pane 202, entity Acme is presented with three navigation controls 214, correlating to three additional tabs 216 at the top of the dashboard 200. A first navigation control 214a, when selected, presents entity Acme with detailed information regarding health plan subsidies provided to employees within a “health subsidy” tab 216b. A second navigation control 214b, when selected, presents entity Acme with detailed information regarding disability plan subsidies provided to employees within a “disability subsidy” tab 216c. A third navigation control 214c, when selected, presents entity Acme with information regarding life insurance subsidies within a “life subsidy” tab 216d.

In a present “overview” tab 216a, the dashboard 200 provides a number of selectable controls to entity Acme, organized within a series of information panes 204, 206, 208, 210, and 212. In the first information pane 204, the dashboard 200 provides de-identified (e.g., anonymous) information regarding employee profile information and employee medical history data collected from individual users employed by entity Acme. In some implementations, a “view all” control 218, when selected, presents entity Acme with personal information regarding individual employees, including aggregated profile information (e.g., zip code distribution or geographic region distribution) and demographic information (e.g., age distribution, gender distribution, race distribution, etc.). The medical history information presented by the “view all” control 218, for example, may present information regarding claims filed by employees of Acme Co. via the dashboard system and environment. If employees of Acme Co. uploaded external medical history records, the “view all” control 218 may provide entity Acme with a comprehensive review of aggregated and de-identified medical history data.

If entity Acme wishes to link employee medical history data gleaned from electronic medical records to the dashboard interface 200, in some implementations, entity Acme selects an “upload medical histories” control 222. The control 222, upon selection, may execute a de-identification process via the dashboard system so that the dashboard system may share individual user medical history, upon individual employee authorization, as de-identified data. In this manner, entity Acme may access information regarding employees without incurring privacy concerns. The de-identification process, for example, may be based upon governmental guidelines, such as the U.S. Health Insurance Portability and Accountability Act (HIPAA) guidelines of 1996.

Alternatively, in other implementations, selection of the “upload medical histories” control 222 may provide individual users with a connection between the dashboard system and a third party electronic medical record repository. Upon authorization and validation of each individual user employed by the entity, for example, the respective individual user's electronic medical records (or a portion thereof) may be accessed by the respective individual user via the dashboard system. In this manner, for example, the dashboard system can provide entity Acme's employees with value-added features based upon analysis of the contents of the electronic medical records, as described above in relation to FIG. 1.

In some implementations, entity Acme can choose to authorize access of the de-identified medical history data by one or more industry participants. By selecting an “authorize access by carrier” control 220, for example, entity Acme may authorize the dashboard system to share employee medical history information with one or more carriers, such as the carriers associated with employer sponsored medical plans (e.g., described in relation to information pane 208), employer sponsored life insurance plans (e.g., described in relation to information pane 210), and/or employer sponsored disability plans (e.g., described in relation to information pane 212). The data shared with each industry participant may correspond to only those individual users who have subscribed to products offered by the particular industry participant. In another example, all individual user data is shared, in anonymous fashion, with either each industry participant within the dashboard system or each industry participant sponsored by entity Acme.

In some implementations, employer Acme may select a “comparisons to other companies in your sector” control 224 to view a comparison between de-identified information gleaned from the individual user profiles and/or individual user medical records of employees of entity Acme and de-identified aggregate information gleaned from employees of other similar entities. The comparison, for example, may identify additional entities used for comparison based upon business sector (e.g., known competitors or peers). In other examples, the dashboard 200 may present entities for comparison based on geographic location, size, and/or maturity. The selected entities may be anonymized, for example listed as “Competitor A” rather than as “Sprocket Co.” In presenting a comparison, main factors contributing to differences in risk scores between the entities may be highlighted. For example, Competitor A may have a greater number of employees with children, while Acme Co. has a greater number of employees close to retirement age. The entities selected for comparison, in some embodiments, include other entities participating within the dashboard system and environment. In some embodiments, one or more entities selected by the dashboard for comparison are not members of the dashboard system and environment. For example, the dashboard system and environment may import data provided from an external source to increase visibility in risk scores, medical history trends, premium levels, and other factors in the industry participants' particular industry.

Turning to the risk score information pane 206 of the dashboard 200, a “your group risk score” control 226, upon selection, presents entity Acme with information regarding the group risk score assigned to entity Acme. The group risk score is based upon risk scores of the employees of entity Acme Co. as well as additional (e.g., dependent) individual users of employee plans. The risk score information, in some examples, may include the total score as well as, optionally, individual factors contributing to the group risk score. Alternatively, rather than presenting the information upon selection of the “your group risk score” control 226, the risk score pane 206 may present a total risk score value (e.g., in the position of the “your group risk score” control 226), while additional controls within the risk score pane 206 may present details underlying the composition of entity Acme's group risk score.

In some implementations, entity Acme selects a “primary factors affecting your group risk score” control 230 to learn about the composition of the group risk score. For example, a number of factors may contribute to a group risk score computation model such as, in some examples, median or average age of employee population, gender ratio, race composition, geographic region(s) where the employees work, type of industry (e.g., riskiness of job-related tasks) and medical claims history. The primary factors, for examples, may be based upon analysis of group medical claims and/or pharmacy claims data. To further refine information, if entity Acme is a large employer having a number of physical locations and/or a number of types of business units, factors affecting the group risk score may be analyzed, in some examples, on a per-locale or geographic region basis, a per-job-capacity basis (e.g., manufacturing compared to engineering, etc.), and/or a per-corporate-division basis (e.g., a retail entity broken down by store type or name).

In some implementations, analysis of the primary factors involves reviewing self-reported health assessment information. For example, individual users may be provided a survey to determine attitudes, beliefs, motivators, and/or present wellness behaviors (exercise levels, eating habits, etc.). In another example, entities may provide on-site biometric screenings or other health assessments to individual users as part of a wellness program. The primary factors may include factors that could be influenced by entity Acme through health improvement programs and employee competitions. Factors within the influence of entity Acme, for example, include smoking status, weight, and/or blood pressure. The “primary factors affecting your risk score” control 230, upon selection, may present the risk score factors to entity Acme to encourage entity Acme to take the initiative with employee programs to improve the group risk score. In some circumstances, a portion of the statistics presented may only take into account the employees of entity Acme, rather than including dependents of the employees, such that internal programs are planned according to the needs of those working for entity Acme.

Furthermore, in some implementations, entity Acme may contribute data regarding individual users for use in risk score analysis. For example, should entity Acme offer one or more wellness programs, participation in the wellness programs (e.g., a walking program, bicycling to work program, weight loss program, etc.) may be reported to the dashboard system for analysis to further refine and revise factors contributing to the risk assessment score. In another example, entity Acme may submit reports of sick days accrued, disability reporting, workers' compensation reporting, incidental employee absenteeism, and/or utilization of vacation days as evidence of wellness levels of employees. The data supplied by entity Acme may be aggregated anonymous data and/or data representative of individual users (e.g., based upon privacy rights, employee opt-in (or opt-out) of program analysis, etc.).

In some implementations, the “primary factors affecting your group risk score” control 230, upon selection, presents entity Acme with an estimate of the costs associated with individual users who are at higher medical risk than average. For example, the individual users may be categorized based upon assessed risk involving one or more factors. The categories, in some examples, may include “normal”, “moderate”, and “high” risk, “low”, “average”, and “high” risk, or percentile risk (e.g., average, 75^{th} percentile, 95^{th} percentile, etc.). In a particular example, employee salary information is combined with employee absenteeism to estimate a cost of productivity loss. In another example, medical claims data is aggregated to compare medical claims costs between the different categories of employees.

A “compare to averages for other companies in your sector” control 232 of the dashboard 200 is selectable to cause display of a comparison of a group risk score of entity Acme (illustrated via “your group risk score” control 226) to additional entities. The comparison, for example, may identify additional entities used for comparison based upon business sector (e.g., known competitors or peers). In other examples, the dashboard may present entities for comparison based on geographic location, size, and/or maturity. The additional entities may be anonymized, for example listed as “Competitor A” rather than as “Sprocket Co.” In presenting a comparison, modifiable factors contributing to differences in risk scores between the companies may be highlighted. For example, Competitor A may have a greater number of smokers within the work force, while Acme Co. has a lower average BMI. The entities selected for comparison, for example, can include other entities within the dashboard system and environment. In another example, one or more entities selected by the dashboard system for comparison are not members of the dashboard system and environment. For example, the dashboard system and environment may import data provided from an external source to increase visibility in risk scores, medical history trends, premium levels, and other factors in the industry participants' particular product industry.

In some implementations, the “compare to averages for other companies in your sector” control 232 of the dashboard 200, upon selection, presents entity Acme with a comparison of estimated costs accrued by entity Acme in comparison to peer entities due to employees with escalated health risks. In one example, aggregate estimated cost of productivity loss of employees of entity Acme is compared to aggregate estimated costs of productivity loss for a number of peer entities.

In some implementations, entity Acme selects a “risk scores provided by carriers” control 228 to review risk scores determined by individual industry participants (e.g., plan carriers). The industry participants, for example, may each use internal algorithms for determining risk score. The factors contributing to risk scores generated by industry participants may or may not be known. For example, the industry participant may optionally volunteer information regarding factors which contribute to risk score determinations.

The three remaining information panes 208, 210, and 212 of the dashboard 200 share identical controls, each set of controls providing information related to the various plans subscribed to by employees of entity Acme Co. and/or sponsored by entity Acme Co. for employee selection. As such, the medical plan pane 208, the life insurance plan pane 210, and the disability plan pane 212 are described in general as containing plan controls 234, 236, 238, and 240. However, the information presented will differ, upon selection of the plan controls 234, 236, 238, and 240, based upon the type of plan being reviewed by entity Acme.

A “summary of current plan offerings” control 234, when selected, presents entity Acme with summary information regarding one or more products sponsored by entity Acme Co. The summary information, in the example of medical plans, may include co-pay information, network providers, deductible information, and other medical plan features. If a particular product of entity Acme's products is a self-insurance plan, in another example, entity Acme may be presented with cost of access to the industry participant's network and/or cost of administrative services for claims processing related to that product. Similarly, the summary information, in the example of a life insurance plan, may include term, rate, death benefit, accidental death benefit, and present value. If entity Acme sponsors two or more products within a particular category (e.g., medical, life, or disability insurance) or, alternatively, entity Acme has employees subscribed to two or more products within a particular category, the dashboard 200 may present entity Acme with information related to each of the two or more products. In one example, the product information may be presented side-by-side, for example in a comparison format. In another example, the dashboard 200 may present a list of current products to entity Acme, upon selection of the “summary of current plan offerings” control 234, and entity Acme may select a particular product for review.

To compare the present coverage with coverage offered by other (competitor or peer) entities, in some implementations, entity Acme selects a “compare to coverages offered by other companies in your sector” control 238 of the dashboard 200. Upon selection of the “compare to coverages offered by other companies in your sector” control 238, the dashboard 200 may present entity Acme with information regarding products sponsored by competitors and/or peers of entity Acme. If, instead, entity Acme provides individual users with a defined contribution, the dashboard 200, upon selection of the “compare to coverages offered by other companies in your sector” control 238, may present a comparison of defined contribution levels provided by additional entities. Further, upon selection of the control 238, entity Acme may be presented with peers providing traditional insurance plan options and/or peers engaging in self-insurance services options. For example, if entity Acme's current products involve traditional insurance plan options, entity Acme may be presented with both one or more peers providing traditional insurance plan options and one or more peers engaging in self-insurance services options to allow entity Acme to weigh potential benefits of pursuing the self-insurance services option. Conversely, if entity Acme's current products include a self-insurance services options, entity Acme may be presented with both one or more peers providing self-insurance service options and one or more peers engaging in traditional insurance plan options to allow entity Acme to weigh the potential benefits of pursuing a traditional insurance plan option. As described above in relation to controls 224 and 232, the additional entities may be selected based upon a number of factors and may optionally be presented in an anonymous fashion. Additionally, if entity Acme offers a defined contribution rather than a selection of sponsored products, entity Acme may be compared, in some embodiments, only to other entities offering a defined contribution.

A “ratings of current plans relative to peers” control 240 of the dashboard 200 presents, upon selection, information regarding user ratings (e.g., individual user ratings and/or entity ratings) submitted regarding the products subscribed to by entity Acme in comparison to ratings submitted regarding the products subscribed to by other entities identified as competitors and/or peers of entity Acme. Identification of an entity as a peer, in some examples, can include comparing entity demographic information of the entity Acme to additional entities external and/or internal to the dashboard exchange system and environment. In one example, the peers of entity Acme include other entities within a same employment sector. The demographics, in other examples, can include geographic location, size, and/or maturity. The ratings, for example, may be based upon a sliding scale, number of stars, or other rating mechanism demonstrating a level of satisfaction a particular individual user or entity has with a particular product. Ratings of peers external to the dashboard exchange system and environment may be obtained, in some examples, through contractual arrangements with third-parties or industry participants, public domain information, ‘estimated’ or calculated ratings generated within the dashboard system and environment, rating boards, or standardized reporting mechanisms, among others. In one example, various aspects of a product may be rated separately. For example, the dashboard system may maintain (and/or obtain) separate individual user customer service ratings, entity customer service ratings, individual user billing ratings, and entity billing ratings for each product and/or industry participant. The dashboard system, in another example, may maintain (and/or obtain) separate provider network ratings, product feature ratings, and economic value ratings associated with each product offered by a particular industry participant.

Should entity Acme discover that competitors appear to offer superior benefits in one or more product areas (e.g., medical insurance, life insurance, or disability insurance), in some implementations, entity Acme selects an “options from other carriers” control 236 to review products not presently subscribed to by entity Acme. The products, for example, may include traditional insurance product options and/or self-insurance services options offered by one or more industry participants. The products presented, in some embodiments, depend upon entity Acme's current products. For example, if entity Acme is presently engaging in the dashboard environment as a self-insured industry participant, entity Acme may be presented, upon selection of the “options from other carriers” control 236, with a greater concentration of and/or promoted focus of self-insurance services options as compared to an entity participant that only has traditional products, and vice-versa.

Although the entity dashboard 200 is described in general terms, the controls presented may vary depending upon the level of user accessing the dashboard 200. For example, a benefits professional or human resources representative may be provided only a subset of the controls presented to a board member or managing officer. Similarly, the information accessible via the tabs 216 may change depending upon the level of user accessing the information.

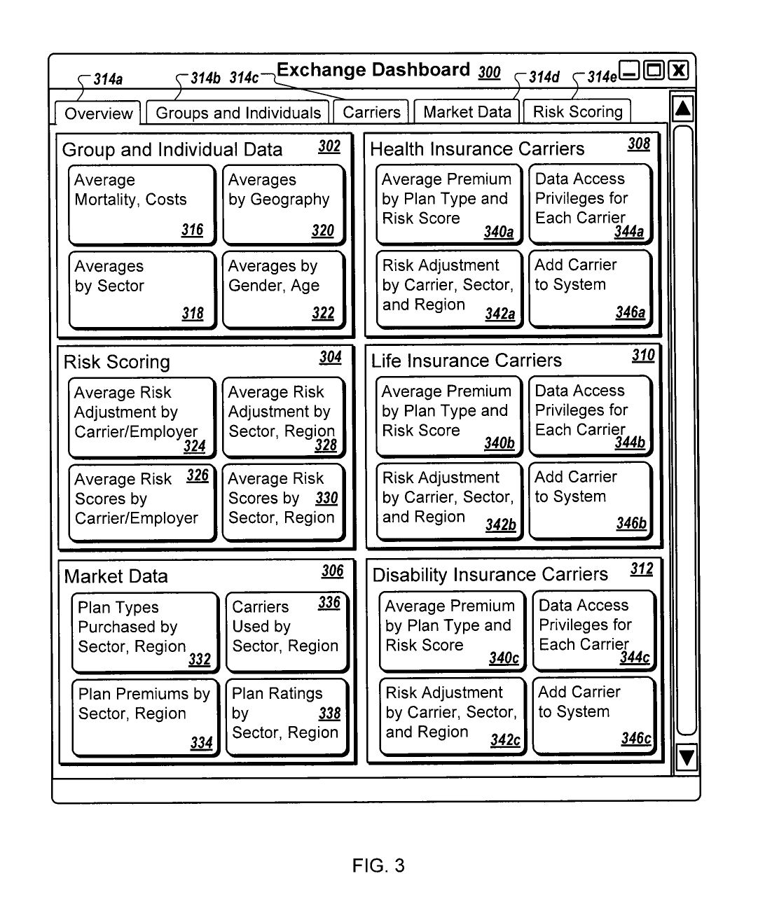

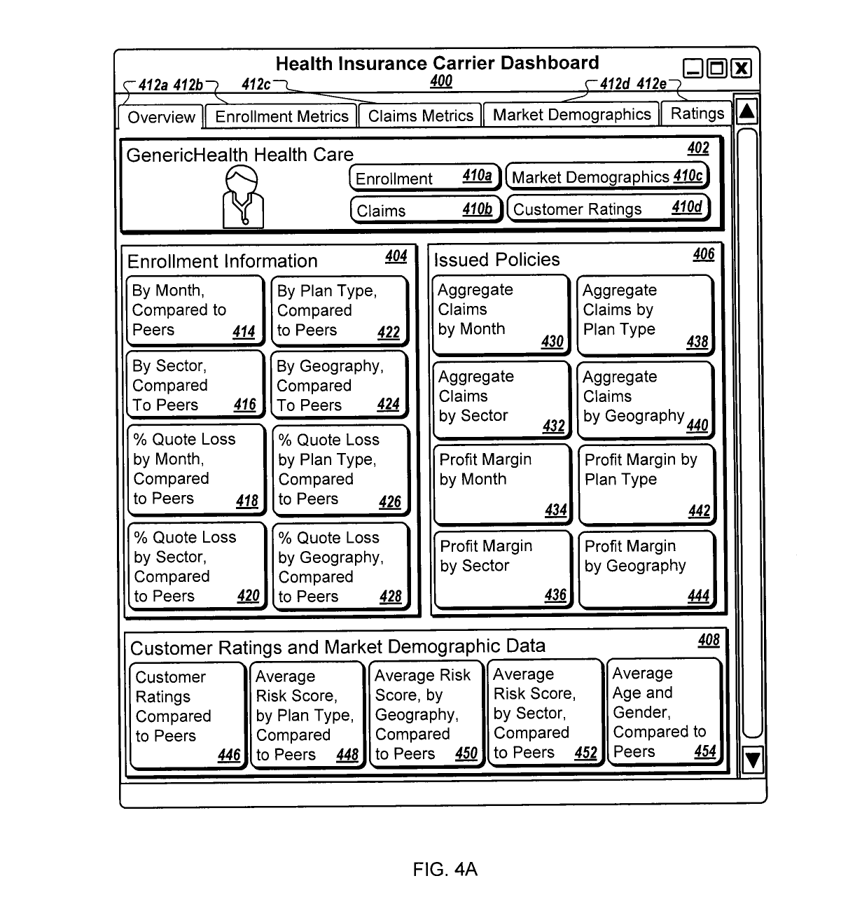

FIG. 3 is a screen shot of an example dashboard user interface 300 for accessing information about a dashboard system. The dashboard 300 is part of a web site, web portal, personal computer application, or mobile device application configured to allow a member of the dashboard system team to review analytics regarding the dashboard system and environment.

The dashboard 300 includes a group and individual data pane 302 presenting information regarding product interaction and activity analytics (e.g., claims, customer service interactions, etc.) across individual users and/or groups (e.g., demographic groups, employment sector groups, etc.). A more detailed overview of the information represented in the group and individual data pane 302 is accessible using a “groups and individuals” tab 314b. The “groups and individuals” tab 314b, for example, may present the user upon selection with small graphical displays representing a portion of the analytics accessible through the group and individual data pane 302. In the group and individual data pane 302, an “average mortality, costs” control 316, when selected, presents a user with analytics regarding the costs incurred (e.g., insurance claims, prescription drug costs, and/or other reimbursement expenses) by individual users of the dashboard system and environment. The costs, for example, may be broken down by timeframe (e.g., daily, weekly, monthly, quarterly, etc.). In another example, the costs may be broken down by product type (e.g., health insurance, life insurance, disability insurance, etc.). The mortality data, similarly, may illustrate average anticipated mortality age of individual users of the dashboard system and environment (e.g., based upon risk score and age analysis), also broken down by timeframe and (optionally) product type subscribed to. For example, not all entities will carry all product types available through the dashboard system and environment and, similarly, not all individual users will obtain all product types.

Beneath the “average mortality, costs” control 316, an “averages by sector” control 318, upon selection, may present the user with a breakdown of the overall data described above, on a per-sector basis. The sectors, for example, may include a variety of employment sectors (e.g., medical, technological, academic, manufacturing, retail, services, etc.) and other individual user classifications, such as “retired”, “student”, “minor”, and “unemployed.” The averages by sector presented in response to selection of the “averages by sector” control 318 may include comparisons of cost and/or mortality data between the various sectors. In one example, the dashboard 300 may present a ranking of the sectors, such as the highest cost sector to lowest cost sector.

The group and individual data pane 302 also includes an “averages by geography” control 320, selectable for presentation of a breakdown of the overall data described above in relation to control 316, on a geographical region basis. The geographical regions, for example, may include a series of refinements of information starting on a per country or per continent basis, and reducing to a state, province, or in-state region (e.g., zip code or county). The averages by geography presented in response to selection of the “averages by geography” control 318 may include comparisons of cost and/or mortality data between the various geographical areas. In one example, the dashboard 300 may present a ranking of the geographical regions, such as the youngest average age of mortality geographical region to oldest average age of mortality geographical region.

Beneath the “averages by geography” control 320, an “averages by gender, age” control 322, upon selection, may present the user of the dashboard 300 with a breakdown of the overall data described above, on a per-gender and/or per-age range basis. The age ranges, for example, may include individual user classifications, such as “infant,” “minor,” “adult,” and “senior citizen.” In another example, age ranges may include age spans of individual users based upon stages of maturity, such as infant (e.g., about 0 to 2), preschool (e.g., about 3 to 5), grade school (e.g., about 6 to 10), junior high (e.g., about 11 to 13), high school (e.g., about 14 to 17), college (e.g., about 18 to 23), early adulthood (e.g., about 24 to 34), on up to retirement (e.g., 64+) and/or geriatric. Other age ranges may be set by even time frames (e.g., 5, 10, or 20 year segments). The averages by gender and/or age presented in response to selection of the “averages by gender, age” control 318 may include comparisons of cost and/or mortality data between the various age ranges and/or the two genders. In one example, the dashboard 300 may present a ranking of the age ranges, such as the highest cost age range (and, optionally gender within the age range) to lowest cost age range.

Although illustrated as separate controls 316, 318, 320, and 322, in some implementations, the user may select the “groups and individuals” tab 314b of the dashboard 300 to access more detailed analytics of the average mortality and costs data, such as averages by employment sector within selected geographical regions, averages by gender within selected employment sectors, or averages by age and further by gender within selected geographical regions. Any combination may be possible. Further, the data may be illustrated numerically, in a bar graph, pie chart, line graph, or other visual layout presented to allow the user to quickly synthesize the information.

Turning to a risk scoring pane 304 and corresponding “risk scoring” tab 314e, the user selects the available controls to access information regarding risk analytics across individual users and/or groups (e.g., demographic groups, employment sector groups, etc.). The “risk scoring” tab 314e, for example, may present the user with small graphical displays representing a portion of the analytics accessible through the risk scoring pane 304.

In the risk scoring pane 304, an “average risk adjustment by carrier/employer” control 324, when selected, presents a user with analytics regarding risk adjustments applied to industry participants by the dashboard system based upon subscriber pool, as well as risk adjustments associated with various entities. A risk adjustment strategy employed by the dashboard system redistributes premiums to the affiliated industry participants based upon risk scoring of subscriber pools of each industry participant. As risk scores can be applied both prospectively (e.g., based upon anticipated costs associated with the subscriber) and retrospectively (e.g., based upon actual claims data accrued by a particular subscriber), the risk adjustment strategy can similarly work in a prospective and/or retrospective manner. The risk adjustment strategy is designed to allocate premium adjustments to the industry participants affiliated with the dashboard system such that premium payments are allocated according to risk (e.g., anticipated or actual cost) born by each individual industry participant. In this manner, the dashboard system redistributes the risk of providing coverage for the least healthy (highest cost/highest risk) participants, thereby reducing the incentive for individual industry participants to increase premiums based upon risk analysis of the subscriber pool and enhancing stability in future premium levels. A positive assessed risk is applied to those industry participants with subscribers having a lower than average aggregate risk score, and a negative assessed risk is applied to those industry participants with subscribers having a higher than average aggregate risk score. Should an industry participant's aggregate risk score match the average of the dashboard system, that industry participant is allocated a neutral risk assessment (e.g., “0” risk adjustment). When premiums are paid into the dashboard system by the entities and/or individual users, the premium payments to each of the industry participants are adjusted according to their individual risk assessments. Example risk assessment and premium adjustment schemes are described in greater detail in U.S. patent application Ser. No. 13/231,601 to Sperling, filed Sep. 13, 2011, incorporated herein by reference in its entirety. Returning to the “average risk adjustment by carrier/employer” control 324, in the circumstance of a large entity (e.g., international, multi-national, or multi-regional entity), the information may be broken down by geographic area and/or business subsidiary. The risk adjustments, furthermore, may be separated by product type (e.g., health insurance, life insurance, disability insurance, etc.).

By selecting an “average risk adjustment by sector, region” control 328, the risk adjustments applied through the dashboard system may be presented broken down by employment sector and/or geographical region. The sectors, for example, may include a variety of employment sectors and other individual user classifications, such as “retired”, “student”, “minor”, and “unemployed.” The average risk adjustments by sector presented in response to selection of the “average risk adjustment by sector, region” control 328 may include comparisons of risk adjustment between the various employment sectors. In one example, the dashboard 300 may present a ranking of the employment sectors, such as the most negative (greatest overall risk) risk-adjusted sector to most positive (lowest overall risk) risk-adjusted sector. In terms of geographical regions, the dashboard 300 may offer a series of refinements of information starting on a per-country or per continent basis, and reducing to a state, province, or in-state region (e.g., zip code or county).

In addition to risk adjustment data, the risk scoring pane 304 is configured to present information regarding risk scores, such as an “average risk scores by carrier/employer” control 328 which, upon selection, presents a breakdown of risk scores by industry participant and/or entity in a manner similar to that of risk adjustments (described above in relation to control 324) and an “average risk scores by sector, region” control 330 which presents, upon selection, a breakdown of risk scores by sector and/or region in a manner similar to that of risk adjustments, described above in relation to control 328. These risk scores, for example, may be tracked over time to assess overall risk in the system as well as areas in which risk is increasing (or decreasing) at the greatest rate.

Although illustrated as separate controls 324, 326, 328, and 330, in some implementations, the user may select the “risk scoring” tab 314e of the dashboard 300 to access more detailed analytics of the risk adjustment and risk score data, such as averages by employment sector within selected geographical regions, averages by industry participant within selected employment sectors, or averages by industry participant within selected geographical regions. Any combination may be possible. Further, the data may be illustrated numerically, in a bar graph, pie chart, line graph, or other visual layout presented to allow the user to quickly synthesize the information.

Turning to a market data pane 306 and corresponding “market data” tab 314d of the dashboard 300, the user selects the available controls to access information regarding plan subscription trends and consumer ratings. The “market data” tab 314d, for example, may present the user, upon selection, with small graphical displays representing a portion of the analytics accessible through the market data pane 306. In the market data pane 306, a “plan types purchased by sector, region” control 332, when selected, presents a user with analytics regarding product purchase on a per-sector and/or per-region basis. The product types, for example, may be separated into major divisions (e.g., medical insurance, life insurance, disability insurance) as well as sub-divisions thereof. For example, in relation to medical products, the dashboard 300 may present information regarding purchase trends in family coverage medical plans, individual coverage medical plans, and individual plus one medical plans. Furthermore, the dashboard 300 may present information regarding purchase trends in types of medical plans, such as preferred provider organization (PPO), exclusive provider organization (EPO), and health maintenance organization (HMO).

If the dashboard system provides standardized product types, the level of specificity may reduce further, such as to a product type level of particular sub-division, by product type and further by feature set. In a particular example, the dashboard 300, via the “plan types purchased by sector, region” control 332, may present subscription volume (or percentage) data regarding PPO-type individual coverage plan with a two thousand dollar deductible. The user may review information, by selecting the “plan types purchased by sector, region” control 332, that is broken down by employment sector and/or geographical region. The sectors, for example, may include a variety of employment sectors and other individual user classifications, such as “retired”, “student”, “minor”, and “unemployed.” The product type purchases by sector presented in response to selection of the “plan types purchased by sector, region” control 332 may include comparisons of the number of subscriptions purchased per product type between the various employment sectors. In another example, the dashboard 300 may present an analysis of market share by product type and region. In one example, the dashboard 300 may present a perceived underutilization of product type within one or more of the employment sectors, such as underutilization of disability insurance within a particular employment sector. In terms of geographical regions, the dashboard 300 may offer a series of refinements of information starting on a per-country or per continent basis, and reducing to a state, province, or in-state region (e.g., zip code or county).

A “plan premiums by sector, region” control 334, upon selection, causes the dashboard 300 to present the user with analytics regarding premium costs on a per-sector and/or per-region basis. In illustrating premiums analytics, the dashboard 300 may separate the plan subscription data into major divisions (e.g., health insurance, life insurance, disability insurance). The sectors, for example, may include a variety of employment sectors and other individual user classifications, such as “retired”, “student”, “minor”, and “unemployed.” The dashboard 300, in one example, may present information regarding average, median, and range of premiums charged to students. In terms of geographical regions, the dashboard 300 may offer a series of refinements of information starting on a per-country or per continent basis, and reducing to a state, province, or in-state region (e.g., zip code or county). In another example, the dashboard 300 may present a ranking of the geographic regions (e.g., major geographic areas of the United States), such as the highest premium region to lowest premium region.

By selecting a “carriers used by sector, region” control 336, the dashboard 300 presents the user with analytics regarding industry participant subscriptions on a per-sector and/or per-region basis. The subscriptions may be separated into major divisions (e.g., health insurance, life insurance, disability insurance). The dashboard 300, in one example, may present information regarding relative market share between industry participants competing in a particular geographic region. In another example, the dashboard 300 may present information regarding top industry participants within a subset of market sectors, such as the top industry participants selected by retirees. The sectors, for example, may include a variety of employment sectors and other individual user classifications, such as “retired”, “student”, “minor”, and “unemployed.” In terms of geographical regions, the dashboard 300 may offer a series of refinements of information starting on a per-country or per continent basis, and reducing to a state, province, or in-state region (e.g., zip code or county).

The user, in some implementations, selects a “plan ratings by sector, region” control 338 to review analytics regarding plan ratings on a per-sector and/or per-region basis. The ratings, for example, may be based upon a sliding scale, number of stars, or other rating mechanism demonstrating a level of satisfaction a particular individual user or entity has with a particular industry participant or product. In one example, various aspects of a product and/or industry participant may be rated separately. For example, the dashboard system may maintain separate individual user customer service ratings, entity customer service ratings, individual user billing ratings, and entity billing ratings for each industry participant. The dashboard system, in another example, may maintain separate provider network ratings, product feature ratings, and economic value ratings associated with each product offered by a industry participant. The subscriptions may be separated into major divisions (e.g., health insurance, life insurance, disability insurance). The dashboard 300, in one example, may present information regarding relative approval of a particular product or a product type (e.g., life insurance plans) offered by a particular industry participant based upon ratings submitted by individual users residing in various geographic regions. In another example, the dashboard 300 may present information regarding top-rated industry participants within a subset of market sectors, such as the top industry participants selected by technology employers. The sectors, for example, may include a variety of employment sectors and other individual user classifications, such as “retired”, “student”, “minor”, and “unemployed.” In terms of geographical regions, the dashboard 300 may offer a series of refinements of information starting on a per-country or per continent basis, and reducing to a state, province, or in-state region (e.g., zip code or county).

Although illustrated as separate controls 332, 334, 336, and 338, in some implementations, the user may select the “market data” tab 314d of the dashboard 300 to access more detailed analytics of the market data, such as product ratings relative to product premium rates, geographically. Any combination may be possible. Further, the data may be illustrated numerically, in a bar graph, pie chart, line graph, or other visual layout presented to allow the user to quickly synthesize the information.

The three remaining information panes 308, 310, and 312 of the dashboard 300 share identical controls, each set of controls providing information related to the various products available to entities and/or individual users interacting with the dashboard system and environment. As such, the medical plan pane 308, the life insurance plan pane 310, and the disability plan pane 312 are described in general as containing plan controls 340, 342, 344, and 346. However, the information presented will differ, upon selection of the plan controls 340, 342, 344, and 346, based upon the type of product being reviewed by the user. Furthermore, detailed information regarding industry participant analytics is available to the user by navigating to a “carriers” tab 314c.

In some implementations, the user selects an “average premium by plan type and risk score” control 340 to review average premiums charged by industry participants based upon a plan type (e.g., medical plans 340a, life insurance plans 340b, or disability plans 340c) and a risk score. The risk score may encompass a numeric value. In another example, the risk score encompasses a range of numeric values. Further, upon selection of the “average premium by plan type and risk score” control 340, the user may be presented with information regarding the largest increases in premiums (e.g., between a risk score of X and a risk score of Y).

Through selection of a “risk adjustment by carrier, sector, and region” control 342, the dashboard 300 presents a user with risk adjustment values applied to the applicable product type (e.g., medical plan products 342a, life insurance plan products 342b, or disability plan products 342c) per industry participant on a regional and/or employment sector basis. The risk adjustment values, in one example, may be tracked over a period of time, such as monthly, quarterly, or annually.

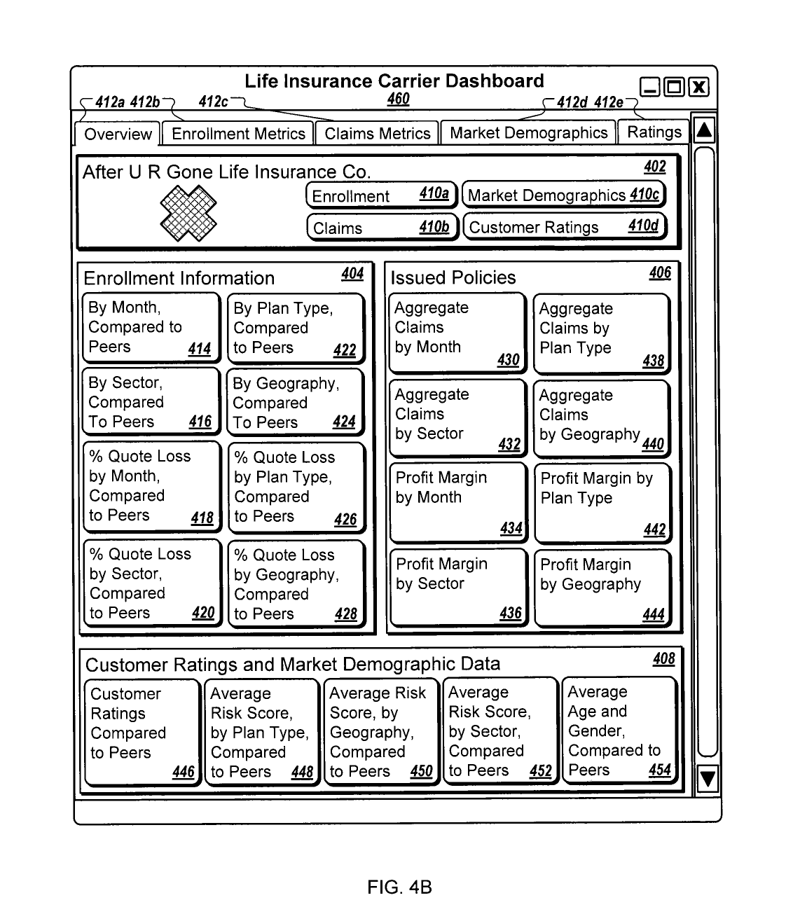

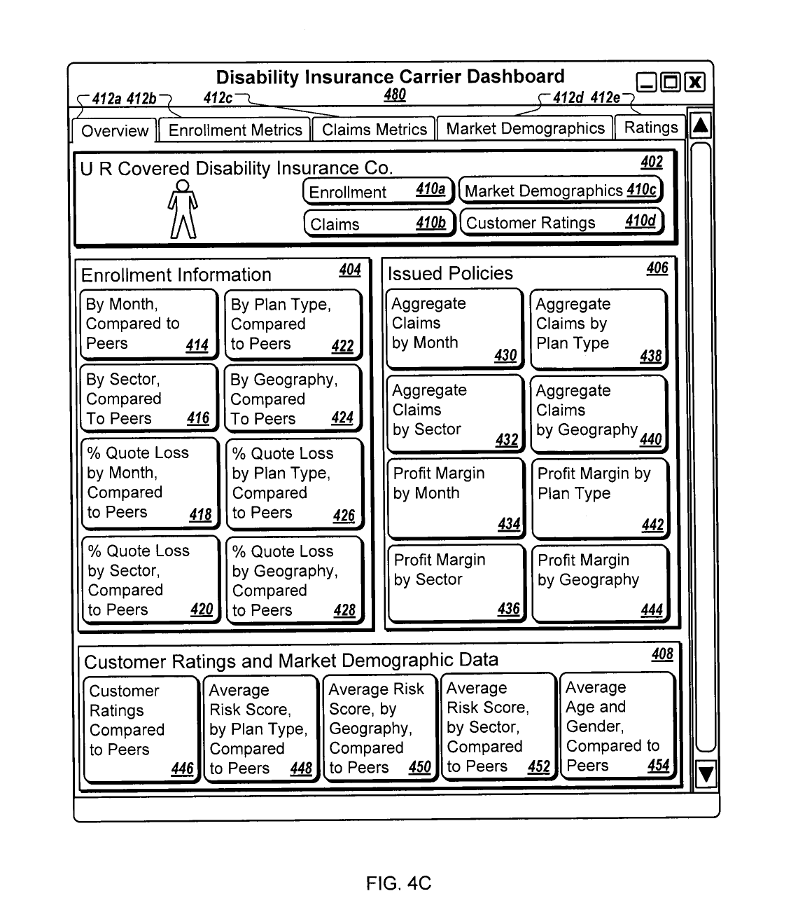

The dashboard 300, upon selection of a “data access privileges for each carrier” control 344, presents access privileges allocated to each industry participant of the particular industry participant type (e.g., health plan carriers 344a, life insurance plan carriers 344b, or disability plan carriers 344c) within the dashboard system. The access level of a particular industry participant may vary based upon the level of information shared by the industry participant with the dashboard system and environment. In another example, the access level of a particular industry participant may depend upon regional laws, such as privacy mandates applied on a per-country, per-state, or per-province basis. The access level, furthermore, may be based in part upon a fee structure charged by the dashboard system. For example, the dashboard system may charge a monthly or annual fee to industry participants for providing access to analytics data. A portion of the analytics data is discussed in relation to FIGS. 4A through 4C, below.

When the user selects an “add carrier to system” control 346, in some implementations, the user is presented with a user interface for adding industry participant information, product information, and other data necessary to add an industry participant to the dashboard system and environment. The industry participant addition process, in some embodiments, includes product type templates for adding information regarding the industry participant's products. For example, upon selection of the “add carrier to system” control 346c, the user may be presented with a disability plan template for importing information regarding one or more disability insurance plans offered by the new industry participant. When adding a new industry participant, in some embodiments, the dashboard system standardizes the product offerings of the industry participant such that products offered through the dashboard system may be compared and/or ported more easily.

Although the dashboard 300 is described in general terms, the controls presented may vary depending upon the level of employee accessing the dashboard 300. For example, an industry participant coordinator or employee benefits coordinator may be provided only a subset of the controls presented to a board member or managing officer of the dashboard system. Similarly, the information accessible via the tabs 314 may change depending upon the level of user accessing the information.

FIGS. 4A through 4C illustrate example dashboards for industry participants to review analytical information and business information related to subscriptions managed within the dashboard system and environment. In some implementations, a portion of the data presented within the industry participant dashboards is accessible only to the particular industry participant reviewing the information. The industry participant may link the portion of the data (e.g., private data) to the dashboard system and environment from a database maintained and managed by the particular industry participant. Similar to an individual user linking in medical history records, the industry participant may opt to link in privately held data to manage and coordinate data points from within the dashboard system and environment. Furthermore, in some implementations, the industry participant is provided the opportunity to share a portion of its private data, in a de-identified manner, to enhance analytics managed by coordinating members of the dashboard system.

FIG. 4A is a screen shot of an example industry participant dashboard user interface 400 for accessing health plan carrier information via a dashboard system. The dashboard 400 is part of a web site, web portal, personal computer application, or mobile device application configured to allow the industry participant (e.g., plan coordinator, actuary, board member, or other corporate official) to interface with the dashboard system and environment. Additionally, although directed towards metrics applicable to a traditional health insurance carrier, portions of the dashboard 400 may be applicable to a self-insured industry participant, such as an entity participant (e.g., an employer having a self-insured administrative services arrangement with one or more of the insurance carrier industry participants). As illustrated, industry participant “GenericHealth” is connected to the dashboard 400.

In a welcome pane 402, industry participant GenericHealth is presented with four navigation controls 410, correlating to four additional tabs 412 at the top of the dashboard 400. A first navigation control 410a, when selected, presents industry participant GenericHealth with detailed information regarding individual user product acquisition statistics within an “enrollment metrics” tab 412b. A second navigation control 410b, when selected, presents industry participant GenericHealth with detailed information regarding product-related interactions and activities (e.g., subscription usage such as insurance claims, customer service interactions, etc.) filed on behalf of enrolled individual users via the dashboard system and environment within a “claims metrics” tab 412c. A third navigation control 410c, when selected, presents industry participant GenericHealth with information regarding market demographics within a “market demographics” tab 412d. A fourth navigation control 410d, when selected, presents industry participant GenericHealth with information regarding customer ratings within a “ratings” tab 412e.

In a present “overview” tab 412a, the dashboard 400 provides a number of selectable controls to industry participant GenericHealth, organized within a series of information panes 404, 406, and 408. In the first information pane 404, the dashboard 400 provides de-identified (e.g., anonymous) information regarding individual user product acquisition, such as enrollment in plans provided by industry participant GenericHealth in comparison to individual user enrollment captured by other industry participants. The peers of industry participant GenericHealth may include all other health plan carriers participating within the dashboard system and environment. If, instead of traditional insurance carrier GenericHealth, a similar interface is provided to an entity participant interacting with the dashboard environment as a self-insured industry participant, the peers of the self-insured industry participant may include the industry participant providing the self-insurance option (e.g., administrative services and/or network access) to the self-insured industry participant as well as, optionally, one or more additional insurance carrier industry participants. In another example, instead of or in addition to insurance carrier industry participants, the peers of a self-insured carrier may include other entity participants participating within the dashboard system and environment in a self-insured industry participant capacity. Peers of industry participant GenericHealth, in some embodiments, are selected based upon identification of competitors to industry participant GenericHealth. For example, the product acquisition information statistics presented via the first information pane 404 may represent comparisons between industry participant GenericHealth and industry participants within a threshold aggregate remittance value, such as a threshold aggregate premium (e.g., aggregate premiums of all enrolled users of all health plans) of industry participant GenericHealth. In another example, industry participant GenericHealth is compared to at least four most similar competitors. Similarities used in identifying peers to industry participant GenericHealth can include, for example, a threshold percentage difference in total number of individual users who have acquired products from industry participant GenericHealth, such as total enrollment by individual users in industry participant GenericHealth plan offerings. The threshold percentage, in a particular example, may be twenty percent. In other examples, peers may include those industry participants with overlapping geographical markets to the geographic market of industry participant GenericHealth or overlapping employment sector markets to the employment sector markets of industry participant GenericHealth. In a further example, peers may be identified based upon having an overlap of product types with the product types offered by industry participant GenericHealth. In some embodiments, the dashboard system anonymizes the peers. For example, a peer of industry participant GenericHealth may be listed as “Competitor A” rather than as “CommonHealth Inc.”

The metrics are represented by a number of selectable controls, including an enrollment “by month, compared to peers” control 414, an enrollment “by sector, compared to peers” control 416, an enrollment “by geography, compared to peers” control 424, and an enrollment “by plan type, compared to peers” control 422. Although illustrated as separate controls 414, 422, 416, and 424, in some implementations, a user may select the “enrollment metrics” tab 412b to access more detailed product acquisition metrics, such as enrollment by month and further by geography, or enrollment by product type and further by sector. Any combination may be possible. Further, the data may be illustrated numerically, in a bar graph, pie chart, line graph, or other visual layout presented to allow a user to quickly synthesize the information. The sectors, for example, may include a variety of employment sectors and other individual user classifications, such as “retired”, “student”, “minor”, and “unemployed.” Product types can include, in some examples, family coverage medical plans, individual coverage medical plans, and individual user plus one medical plans. In another example, product types include managed care types, such as preferred provider organization (PPO), exclusive provider organization (EPO), and health maintenance organization (HMO). Furthermore, product types may be broken down in terms of major features included, such as by deductible level and/or copay level, or including premium features such as “including vision benefit” and “including infertility benefits.” In terms of geographical regions, the dashboard 400 may offer a series of refinements of information starting on a per-country or per continent basis, and reducing to a state, province, or in-state region (e.g., zip code or county).

Beneath the positive acquisition statistic controls 414, 422, 416, and 424, a set of percentage quote loss controls 418, 420, 426, and 428 provide industry participant GenericHealth with insight into product acquisition opportunities quoted by industry participant GenericHealth that were never accepted by individual users of the dashboard system and environment. The level of quoted opportunities that failed to lead to enrollment of a new individual user, as made available by the percentage quote loss controls 418, 420, 426, and 428, are compared to levels of quoted opportunities that failed to lead to enrollment of a new individual user for peers of industry participant GenericHealth. The controls include the “percentage quote loss by month, compared to peers” control 418, the “percentage quote loss by sector, compared to peers” control 420, the “percentage quote loss by plan type, compared to peers” control 426, and the “percentage quote loss by geography, compared to peers” control 428. Peers, geographical regions, plan types, and employment sectors may be identified as described above in relation to the positive acquisition statistic controls 416, 422, and 424. In some implementations, industry participant GenericHealth may select the “enrollment metrics” tab 412b to access more detailed analytics of the percentage quote loss information, such as percentage quote loss by month and further by sector, or percentage quote loss by product type and further by geography. Any combination may be possible. Further, the data may be illustrated numerically, in a bar graph, pie chart, line graph, or other visual layout presented to allow industry participant GenericHealth to quickly synthesize the information.

Turning to the issued policies information pane 406, a first set of controls 430, 432, 438, and 440 are selectable to present metrics regarding the impact of aggregate product-related interactions and activities, such as the cost of aggregate claims. Subscription usage and customer service interaction records, such as insurance claim records, may be filed through the dashboard system and environment, such that the dashboard system has access to the subscription usage and customer service interaction data to derive aggregate metrics, such as the metrics presented by the “aggregate claims by month” control 430, the “aggregate claims by sector” control 432, the “aggregate claims by plan type” control 438, and the “aggregate claims by geography” control 440. In another example, subscription usage and customer service interaction records may be forwarded to the dashboard system by the industry participants for use in data analysis. Geographical regions, product types, and employment sectors may be identified as described above in relation to the positive acquisition statistic controls 416, 422, and 424. In some implementations, industry participant GenericHealth may select the “claims metrics” tab 412c to access more detailed analytics of the aggregate claims data, such as aggregate claims by month and by sector, or average claims by product type and by geography. Any combination may be possible. Further, the data may be illustrated numerically, in a bar graph, pie chart, line graph, or other visual layout presented to allow industry participant GenericHealth to quickly synthesize the information.

A second set of controls 434, 436, 444, and 442 present, upon selection, metrics regarding aggregate transaction data (e.g., profit margins) based upon the aggregate claims data. Profit margin data, such as metrics presented upon selection of the “profit margin by month” control 434, the “profit margin by sector” control 436, the “profit margin by plan type” control 442, and the “profit margin by geography” control 444, may only be derived using information private to industry participant GenericHealth. To provide industry participant GenericHealth with a holistic view of product acquisition and policy information through the dashboard 400, industry participant GenericHealth may have previously opted to link in privately held data to manage and coordinate data points from within the dashboard system and environment. In another example, the dashboard system and environment may provide industry participant GenericHealth with a widget, software algorithm, or software application to be installed within the GenericHealth system. The widget, software algorithm, or software application may import data and/or metrics from the dashboard system and environment into the GenericHealth system and merge the metrics and/or data with data only available within the GenericHealth system. In this manner, the GenericHealth profit margin data may remain within the GenericHealth system (e.g., protected from access by other industry participants participating in the dashboard system) while incorporating information imported from the dashboard system. With this option, for example, the dashboard 400 is generated within the GenericHealth system (e.g., behind a GenericHealth firewall). Geographical regions, plan types, and employment sectors may be identified as described above in relation to the positive acquisition statistic controls 416, 422, and 424. In a particular example, the dashboard system may supply claims-related information, such as identification of individual users, products or product types, and identification of interactions logged within the dashboard system (e.g., claims received, customer service access or other cost-incurring accesses, etc.). In some implementations, a user may select the “claims metrics” tab 412c to access more detailed analytics of the profit margin data, such as profit margin by month and by plan type, or profit margin by sector and by geography. Any combination may be possible. Further, the data may be illustrated numerically, in a bar graph, pie chart, line graph, or other visual layout presented to allow a user to quickly synthesize the information.

Turning to the customer ratings and market demographics data pane 408 of the dashboard 400, a set of controls 446, 448, 450, 452, and 454, when selected, present metrics regarding customer feedback ratings received by the dashboard system and environment related to industry participant GenericHealth and the products provided by industry participant GenericHealth as well as market demographic information regarding the individual users of the dashboard system and environment who have subscribed to and/or purchased products from industry participant GenericHealth. The ratings, for example, may be based upon a sliding scale, number of stars, or other rating mechanism demonstrating a level of satisfaction a particular individual user or entity has with a particular industry participant or product. In one example, various aspects of a product and/or industry participant may be rated separately. For example, the dashboard system may maintain separate individual user customer service ratings, entity customer service ratings, individual user billing ratings, and entity billing ratings related to each industry participant. The dashboard system, in another example, may maintain separate provider network ratings, plan feature ratings, and economic value ratings associated with each product offered by a particular industry participant.

The “customer ratings compared to peers” control 446, upon selection, presents an analysis of customer ratings submitted in relation to industry participant GenericHealth in comparison to customer ratings submitted in relation to peers of industry participant GenericHealth. Peers may be identified as described above in relation to controls 414, 416, 422, and 424. The ratings information, similarly, may be accessed using the “ratings” tab 412e. In presenting the ratings data, separate ratings information may be presented based upon entity submissions as opposed to individual user submissions. The customer ratings may include an overall rating of industry participant GenericHealth as well as ratings associated with each product provided by industry participant GenericHealth. Furthermore, ratings data can include detailed ratings and/or review information provided by individual users and/or entities, for example in the format of a brief survey. In this manner, aspects of plans, such as customer service responsiveness, accuracy of billing, availability of health providers within the network, and other specific details may be addressed individually. In some embodiments, industry participant GenericHealth may conduct individual surveys of individual users and/or entities and merge the survey data (e.g., telephone surveys, online surveys, etc.) into ratings data collected by the dashboard system. Furthermore, the dashboard system and environment may provide industry participant GenericHealth the opportunity to share internally collected statistical data with other industry participants of the dashboard system and environment, thus enriching the information presented via the “customer ratings compared to peers” control 446. The data may be illustrated numerically, in a bar graph, pie chart, line graph, or other visual layout presented to allow the user to quickly synthesize the information.

Controls 448, 450, and 452 relate to risk scores associated with individual users subscribed to products of industry participant GenericHealth as opposed to individual users subscribed to products provided by competitors of industry participant GenericHealth. The risk scores, for example, may be determined based upon an industry participant-specific algorithm, such that industry participant GenericHealth calculates an individual user's risk score differently than a particular competitor may calculate the risk score. Additionally, a basic risk score value may be applied to each individual user by the dashboard system, for example using a customized algorithm to apply a value that is consistent from industry participant to industry participant. In selecting the controls 448, 450, and 452, data representing the dashboard system risk score may be presented. In another example, data representing comparisons of aggregates of the dashboard system risk score between industry participant Generic Health and competitors, as well as comparisons of aggregates of the industry participant-determined risk scores between industry participant Generic Health and competitors are presented. In some implementations, in addition to overall risk score, the averages may include average values of multiple factors contributing to the composition of the subscriber pool's average risk score. For example, a number of factors may contribute to a risk score computation model such as, in some examples, median or average age of subscriber population, gender ratio, race composition, geographic region(s) where the subscribers work or live, employment sector, and medical claims history.

In some implementations, industry participant GenericHealth selects the “average risk score, by plan type, compared to peers” control 448 to learn about average risk scores on a product type basis, in comparison to competitors offering the same product type. The product type refers to a variety of product categories, as described above in relation to control 422.

Industry participant GenericHealth selects the “average risk score, by geography, compared to peers” control 450 to access information regarding subscriber risk scores broken down by geographical region, in comparison to competitors also competing within a same geographic region. Examples of geographic regions are given above in relation control 424.

Upon selection of the “average risk score, by sector, compared to peers” control 452, the dashboard 400 presents industry participant GenericHealth with metrics regarding subscriber risk scores broken down by employment sector, in comparison to competitors also servicing subscribers within the same employment sector. Examples of employment sectors are given above in relation to control 416.

Although illustrated as separate controls 448, 450, and 452, in some implementations, a user selects the “market demographics” tab 314d to access more detailed analytics of the risk score data, such as risk score by product type and further by geography. Any combination may be possible. Further, the data may be illustrated numerically, in a bar graph, pie chart, line graph, or other visual layout presented to allow the user to quickly synthesize the information.

The dashboard 400 presents, upon selection of the “average age and gender, compared to peers” control 454, comparisons of average subscriber demographics (e.g., at least age range and gender) relative to competitors. The age ranges, for example, may include subscriber classifications, such as “infant,” “minor,” “adult,” and “senior citizen.” In another example, age ranges may include age spans of individual subscribers based upon stages of maturity, such as infant (e.g., about 0 to 2), preschool (e.g., about 3 to 5), grade school (e.g., about 6 to 10), junior high (e.g., about 11 to 13), high school (e.g., about 14 to 17), college (e.g., about 18 to 23), early adulthood (e.g., about 24 to 34), on up to retirement (e.g., 64+) and/or geriatric. Other age ranges may be set by even time frames (e.g., 5, 10, or 20 year segments).

The averages by gender and/or age presented in response to selection of the “average age and gender, compared to peers” control 454 may include additional demographic breakdown, such as average by gender and geography, or average by age and employment sector. In some implementations, a user selects the “market demographics” tab 314d to access more detailed analytics of subscriber pool demographics, such as age by plan type or gender by geography. Any combination may be possible. Further, the data may be illustrated numerically, in a bar graph, pie chart, line graph, or other visual layout presented to allow the user to quickly synthesize the information.

FIG. 4B is a screen shot of an example dashboard user interface 460 for accessing industry participant information via a dashboard system. Additionally, portions of the dashboard 460 may be applicable to a self-insured industry participant, such as an entity participant (e.g., an employer) acting in a life insurance plan carrier capacity via an administrative services and/or network access relationship with an insurance carrier industry participant. The dashboard 460 is part of a web site, web portal, personal computer application, or mobile device application configured to allow the industry participant (e.g., plan coordinator, actuary, board member, or other corporate official) to interface with the dashboard system and environment. As illustrated in the welcome pane 402, industry participant “After U R Gone Life Insurance Co.” is connected to the user interface 460.

The dashboard 460 shares the same tabs 412, information panes 404, 406, and 408, and controls 414 through 454 as the dashboard 400 of FIG. 4A. Differences may exist in underlying data, however, due to the nature of life insurance carriers and products as compared to health insurance carriers and products. For example, life insurance product types may include term life insurance and permanent life insurance. Further, term life insurance products may be broken down into lengths of terms or level, while permanent life insurance may be broken down into whole life, universal life, and variable universal life. Additionally, life insurance plans may be divided by premium levels or premium level ranges.

FIG. 4C is a screen shot of an example dashboard user interface 480 for accessing industry participant information via a dashboard system. Additionally, portions of the dashboard 480 may be applicable to a self-insured industry participant, such as an entity participant (e.g., an employer) acting in a disability insurance plan carrier capacity via an administrative services and/or network access relationship with an insurance carrier industry participant. The dashboard 480 is part of a web site, web portal, personal computer application, or mobile device application configured to allow the industry participant (e.g., plan coordinator, actuary, board member, or other corporate official) to interface with the dashboard system and environment. As illustrated in the welcome pane 402, industry participant “U R Covered Disability Insurance Co.” is connected to the user interface 480.

The dashboard 480 shares the same tabs 412, information panes 404, 406, and 408, and controls 414 through 454 as the dashboard 400 of FIG. 4A. Differences may exist in underlying data, however, due to the nature of disability insurance carriers and products as compared to health insurance carriers and products. For example, disability product types may include individual disability insurance, key-person disability insurance, high-limit disability insurance, business overhead expense (BOE) disability insurance, employer-supplied disability insurance, and worker's compensation. Further, disability insurance plans may be broken down by benefit level or benefit level ranges.

Turning to FIG. 5A, an example environment 500 includes a dashboard system 502 for facilitating product exchange between a number of industry participants 504, entities 506, and individual users 508. Industry participants may join the dashboard system 502 to advertise available products to the entities 506 and/or individual users 508. When an entity 506 or individual user 508 accesses the dashboard system 502, a graphical user interface (GUI) engine 534 may present product data 542 associated with products available via the dashboard system 502. Through the GUI engine 534, the entities 506 and/or individual users 508 may review product information and select appropriate products to meet their needs.

A prospective risk analysis engine 516 and/or a retrospective risk analysis engine 520, in some implementations, develop risk assessment data 556 used to determine aggregated risk (e.g., based upon risk data 552 associated with each entity 506 and/or individual user 508) associated with each of the industry participants 504. In some implementations, the risk assessment data 556 is based upon particular population data 544 (e.g., geographic region, age range, gender, etc.). In one example, the retrospective risk analysis engine 516 may analyze claims data 538 and/or prescription data 540, accessed from a data store 512, to anticipate future costs based upon past costs. The claims data 538 and/or prescription data 540, for example, may be provided by the industry participants 504. The prospective risk analysis engine 516, for example, may review individual user data 546 (e.g., demographics information regarding individual users 508 who have obtained products through the dashboard system 502) as well as, optionally, medical diagnosis information provided by the individual users 508 and/or collected from individual user medical records 510 (e.g., accessible from a cloud server or other secure storage location).

In some implementations, a premium adjustment engine 530 adjusts payments to the industry participants 504 according to relative aggregate risk. For example, the amount paid to participating industry participants 504 with small aggregated adopted risk may be reduced, and the amount paid to participating industry participants 504 with large aggregated adopted risk may be increased. The present premium levels may be stored as premiums data 554. A payment engine 518 may coordinate payments between the entities 506 and/or individual users 508 and the industry participants 504. In another example, the entities 506 and/or individual users 508 may submit payments directly to the respective industry participants 504, while the payment engine 518 determines aggregate premium adjustments for each industry participant 504. The payment engine 518, for example, may direct a first portion of industry participants 504 to submit excess premium revenue to the dashboard system for distribution to a second portion of industry participants 504 which are eligible for a premium credit.

A carrier intake and adjustment engine 536, in some implementations, accepts product data 542 from participating industry participants 504. The carrier intake and adjustment engine 536, for example, may classify each product by a particular product type, such that individual users 508 and/or entities 506 may review products by product type. Initial premiums data 554, in one example, may be developed based upon the identified product type. An initial risk level, in another example, may be allocated based upon product type.

In some implementations, an individual user intake and adjustment engine 532 populates entity data 550 and/or individual user data 546 regarding new entities 506 and/or individual users 508. Initial risk data 552 associated with new individual users 508 and/or entities 506 may be developed by the prospective risk analysis engine 516. Individual users 508, in some implementations, may link personal medical records 510 with the dashboard system 502. The GUI engine 534, upon linking the personal medical records 510, may associate individual user claims data 538 and/or prescription data 540 with doctor visits, hospital visits, or other activities captured in the medical records 510 and present aggregated information to an individual user 508 for review.

In some implementations, individual users 508 associated with a particular entity 506 are limited to industry participants 504 and/or products 542 selected by the entity 506. In other implementations, individual users 508, although associated with a particular entity 506, are allocated a product allowance (e.g., defined contribution) by the entity 506. The defined contribution may be identical for all individual users 508 affiliated with the entity 506, all individual users 508 associated with a particular job category or employee level, or variably linked to a salary level of a particular individual user 508. For example, the dashboard system 502 may have access to payroll data from one or more entities 506, used to determine a defined contribution based upon present employee salary. In this manner, as the employee's salary is adjusted, the defined contribution may increase. In some implementations, premiums offered to individual users 508 are priced at a geographic level.

After individual users 508 have obtained products offered by industry participants 504, in some implementations, the individual users 508 and/or entities 506 may have the opportunity to rate individual products and/or submit reviews regarding experiences with the various products and/or industry participants 504. For example, a ratings and review engine 528 may accept ratings data 548 submitted by entities 506 and/or individual users 508. The ratings, for example, may be based upon a sliding scale, number of stars, or other rating mechanism demonstrating a level of satisfaction a particular individual user 508 or entity 506 has with a particular industry participant 504 or product. In one example, various aspects of a product and/or industry participant 504 may be rated separately. For example, the ratings and review engine 528 may maintain separate individual user customer service ratings, entity customer service ratings, individual user billing ratings, and entity billing ratings for each industry participant 504. The ratings and review engine 528, in another example, may maintain separate industry participant network ratings, product feature ratings, and economic value ratings associated with each product offered by a particular industry participant 504.

Based in part upon the ratings data 548, in some implementations, a recommendation engine 526 may provide recommendations to entities 506 and/or individual users 508 who are reviewing available products in the dashboard system 502. The recommendations, in some implementations, may be based at least in part upon demographic information, diagnostic information, or other similarities between product subscribers/purchasers 508 and potential subscribers/purchasers 508. In presenting recommended products, the GUI engine 534 may include selected reviews from reviews data 555. The selected reviews, for example, may include reviews associated with subscribers/purchasers 508 sharing demographic, employer, or medical condition similarities with the potential subscribers/purchasers 508.

In some implementations, the recommendation engine 526 recommends one or more voluntary products in addition to primary products. For example, industry participants 504 may offer voluntary products such as dental, vision, life insurance, vacation medical insurance, identity theft insurance, and/or pet insurance via the dashboard system 502. Information regarding the voluntary products may be stored as voluntary products data 558 in the data store 512. Similar to the primary products, individual users 508 and/or entities 506 may rate or review the voluntary products via the ratings and review engine 528.

As circumstances change for any individual user 508 of the dashboard system 502, the individual user intake and adjustment engine 532 may be used to adjust user data 546. For example, birth, death, adoption, marriage, and divorce may have an effect on a user's interest in a family insurance plan. In one example, a particular individual user 508 may switch jobs, joining a different entity 506, and wish to retain a present insurance plan. A plan porting engine 522 enables the individual user 508 to port a present insurance plan to the new entity 506 or to an individual plan (e.g., upon retirement or conversion to independent employment).

In some implementations, a data mining engine 524 derives statistical information, such as pricing metrics 560, cost metrics 562, and/or efficiency metrics 564 from the claims data 538 and/or prescription data 540. The statistical information, for example, may be used to evaluate industry participants 504, such as on the basis of relative efficiencies. In a particular example, statistical data regarding industry participants 504 is presented within information panes 308, 310, and 312 of the dashboard 300 of FIG. 3. In another example, the statistical information may be used by the prospective risk analysis engine 516, for example to better anticipate future costs based upon cost metrics 562 and/or pricing metrics 560.

In some implementations, aggregated claims data 538 may be shared with the industry participants 504. For example, the industry participants 504 may use the claims data 538 collected from other industry participants 504 to aid in underwriting analysis. The aggregate claims data 538, for example, may correspond to the issued policies information pane 406 of the dashboard 400 of FIG. 4A (as well as the dashboard 460 of FIG. 4B and the dashboard 480 of FIG. 4C). The statistical data may be collected in a data store 514.

At least a portion of the transactions described above in relation to the dashboard system 502 can be performed in real time, while other transactions may be performed in an offline or batch mode operation. For example, transfer of claims data 538 between the industry participants 504 and the dashboard system 502 may be performed in a batch mode operation. Batch communications can include compression of bulk data, such as the prescription data 540.

In some implementations, the communications between the dashboard system 502 and one or more of the industry participants 504, entities 506 and individual users 508 are encrypted or otherwise secured. The dashboard system 502, in some implementations, performs verification of one or more of the industry participants 504, the entities 506, and/or the individual users 508. For example, the dashboard system 502 may verify that a particular individual user 508 is an eligible employee of a particular entity 506.

FIG. 5B is an example environment 570, similar to the example environment 500 but additionally including one or more government exchange systems 572 communicating with the dashboard system 502 and/or one or more of the industry participants 504. The environment 570 allows individual users 508 (and, optionally, entities 506) to shop for plans within the dashboard system 502 while also reviewing plans offered via the federal and/or state exchange.

Industry participants 504, in some implementations, opt to license the dashboard system 502 to act as a government exchange broker. An external exchange plan intake engine 574, for example, may intake information regarding government exchange-based plans, such as product data 542 and remittance data 554. When the dashboard system 502 acts as a licensed broker, the payment engine 518, ratings and review engine 528, and recommendation engine 526, for example, may treat the government exchange plans similarly to any other plan within the dashboard system 502. However, because premiums for the government exchange plans are linked to the government exchange systems 572, the premium adjustment engine 530 will not adjust remittance based upon risk assessment data associated with the government exchange plans.

Further, in some implementations, the dashboard system 502 provides the industry participants 504 and/or government exchange systems 572 the opportunity to link plan offerings into the dashboard system 502. In some implementations, an external exchange rerouting engine 576 may manage linking between the dashboard system 502 and the government exchange system 572 through web links or widgets built into user interfaces generated by the GUI engine 534. Upon selection of the linking mechanisms, a user is redirected to a web portal of the selected government exchange system 572. The government exchange systems 572 may provide ratings data 548 and/or reviews data 555 to the dashboard system 502 for use by the recommendation engine 526 or the dashboard engine 535 to provide an extra level of comparison for the individual users 508 (and/or entities 506).

While the plan porting engine 522 may be capable of porting government exchange plans when acting as a licensed broker of one of the industry participants 504, the plan porting engine 522 may not be able to port plans simply linked into the dashboard system 502 through the government exchange systems 572.

In some implementations, the data mining engine 524 derives statistical information such as pricing metrics 560 regarding licensed government exchange plans and/or linked government exchange plans. The statistical information, for example, may be used to evaluate plans offered through the dashboard system 502 against plans provided through the government exchange systems 572.

In some implementations, the communications between the dashboard system 502 and the government exchange systems 572 are encrypted or otherwise secured. The dashboard system 502, in some implementations, establishes a secure communication link (e.g., virtual private network, networking trunk, etc.) to perform real-time linking of information between the dashboard system 502 and the government exchange systems 572.

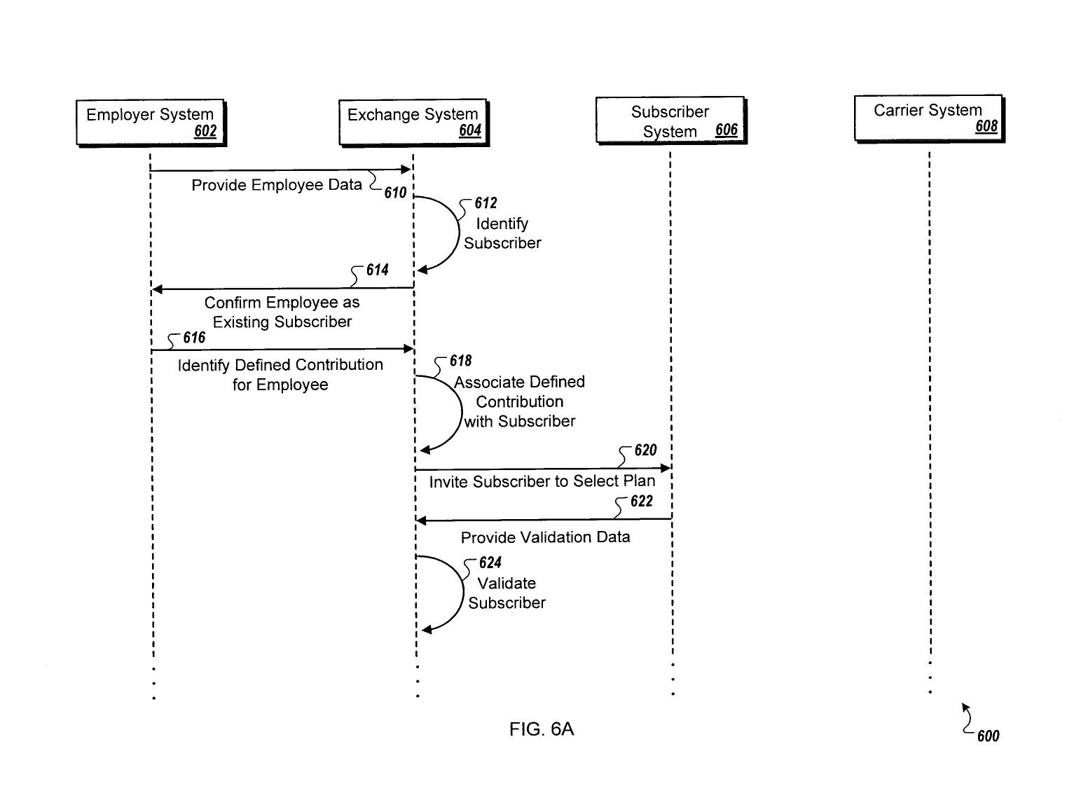

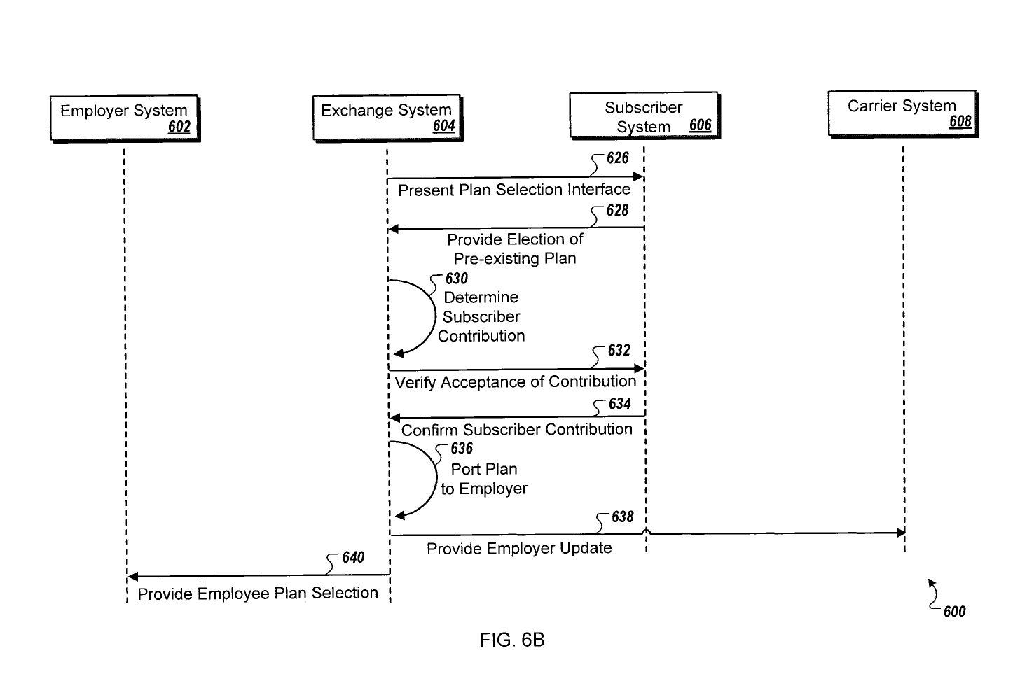

FIGS. 6A and 6B illustrate a swim lane diagram of an example method 600 for porting an insurance plan established by an individual user via a prior employer to the individual user's present employer. The method 600, for example, may be performed by the plan porting engine 522, described in relation to FIG. 5. The plan being ported, for example, may be described through a combination including product data 542 and individual user data 546 (e.g., a “product acquisition profile”), as stored within the data store 512 of FIG. 5A. To port a plan from a prior employer to a present employer or individual plan, an dashboard system 604 communicates with an employer system 602 of the new employer, an individual user system 606 used by the individual user interacting with the dashboard system 604, and an industry participant system 608 of the industry participant providing the plan.

Turning to FIG. 6A, in some implementations, the method 600 begins with the employer system 602 providing employee data (610) to the dashboard system 604. To identify the individual identified within the employee data as a present employee of the employer, for example, the employer system 602 may provide identification data such as name, birth date, social security number, home address and/or phone number. Additionally, in some embodiments, the employer system 602 provides login information for the employee to access the dashboard system 604 via the employer system 602. For example, the employer system 602 may provide an employee email address or other unique employee identifier and, optionally, employee password information, such as a default password. In communicating with the dashboard system 604, in one example, human resource personnel of the employer may access, via the employer system 602, a web portal provided by the GUI engine 534 of FIG. 5A. In another example, the employer system 602 may provide batch data regarding new hires to the dashboard system 604, and the dashboard system 604 may intake the new hire data through the individual user intake and adjustment engine 532 of FIG. 5A.

In some implementations, the dashboard system 604 matches the identification data with a preexisting individual user (612). For example, the individual user intake and adjustment engine 532 may access the data store 512 to match the employee identification data with individual user data 546, as illustrated in FIG. 5A.

In some implementations, the dashboard system 604 issues a confirmation to the employer system 602, confirming that the employee data matches an existing individual user (614). For example, the individual user intake and adjustment engine 532 may present, via a user interface provided by the GUI engine 534, a confirmation regarding the existence of an individual user matching the employee identification data. In some embodiments, if a portion of the identification data fails to match the stored individual user data 546, the individual user intake and adjustment engine 532 may confirm with the employer system 602 that the mismatched information (e.g., address, telephone number, etc.) should be updated to reflect the new information provided by the employer system 602.

Additionally, if the employer funds insurance plans via defined contribution, in some implementations, the employer system 602 provides the dashboard system 604 with identification of a defined contribution associated with the employee (616). The identification, in some examples, may include a dollar amount or employee category. In another example, the identification of the defined contribution may include a payroll identifier that can be used by the dashboard system 604 to access a payroll system of the employer, linking the present salary of the employee as accessed via the payroll system to a defined contribution level.

In some implementations, the dashboard system 604 associates the defined contribution with the individual user (618). For example, the individual user intake and adjustment engine 532 of FIG. 5A may update the individual user data 546 with the defined contribution information provided by the employer via the employer system 602.

If the employer system 602 provided an employee email address for the individual user, in some implementations, the dashboard system 604 issues an invitation (620) to the employee to select a plan via the dashboard system 604. The employee accesses the invitation via the individual user system 606. In other implementations, rather than issuing an invitation through the dashboard system 604, the employer system 602 provides access instructions directly to the employee.

In some implementations, the employee, via the individual user system 606, provides validation data (622) to the dashboard system 604 to validate the employee as an individual user of the dashboard system 604. Note that, although illustrated as separate systems for sake of clarity, in some implementations, the individual user, via the individual user system 606 (e.g., personal computer, tablet PC, or other computing device) accesses a web portal supplied by the employer system 602 to communicate with the dashboard system 604. The validation data, in some examples, can include a user name or employee email address as well as a password or default identification information (e.g., social security number).

In some implementations, the dashboard system 604 validates the individual user (624) using the supplied validation data. In this manner, for example, the dashboard system 604 may guard against unauthorized access to individual user data. A number of security measures may be employed to validate the participate system 606 with the dashboard system 604.

Turning to FIG. 6B, in some implementations, the dashboard system 604 presents a plan selection interface (626) to the individual user system 606. For example, the GUI engine 534 of FIG. 5A may present plan options to the employee. The plan options, in one example, may include various plans recommended by the employer as well as the individual user's plan established with the prior employer. In another example, the dashboard system 604 may simply confirm that the employee would like to continue on the present plan, rather than presenting additional options immediately.

In some implementations, the employee, via the individual user system 606, issues an election (628) to the dashboard system 604 of the pre-existing plan. For example, via a graphical user interface, the employee may click on or otherwise select the pre-existing plan.

In some implementations, the dashboard system 604 determines an individual user contribution towards the premium associated with the pre-existing plan (630). If the employer supplied a defined contribution, for example, the dashboard system 604 determines the premium based upon the defined contribution. If, instead, the employer is the plan purchaser, the dashboard system 604 determines the employee contribution associated with the particular employer. In determining the employee contribution, if the employee has relocated geographically, the dashboard system 604 may adjust the premium based upon present demographic information. For example, the premium adjustment engine 530 may determine a premium associated with the employer's geographic location or the geographic location of a branch where the individual user is employed.

In some implementations, the dashboard system 604 presents the individual user, via the individual user system 606, with information to prompt verification of acceptance of the contribution (632). The contribution, for example, may have changed between the previous employer and the present employer. Furthermore, the dashboard system 604 may present to the individual user, if applicable, the defined contribution amount designated by the employer system 602. In this manner, the employee can verify that the human resources information was entered into the dashboard system 604 correctly.

In some implementations, the employee confirms acceptance of the employee contribution (632) via the individual user system 632, by issuing a confirmation to the dashboard system 604. For example, the employee may click an accept button designating that the employee contribution may be deducted from the employee's paycheck by the employer system 602. Conversely, the employee may enter billing information such as a credit card number for payment of the balance due. Furthermore, the employee may be presented with a variety of payment options, such as monthly billing, weekly billing, or quarterly billing. The payment engine 518 of FIG. 5A, for example, may manage the employee contribution payments. In another example, the exchange system 502 of FIG. 5A may communicate with the payroll system of the entity 506 to establish automatic deduction of the employee contribution.

In some implementations, the dashboard system 604 ports the pre-existing insurance plan to the new employer (636). For example, the plan porting engine 522 of FIG. 5A may port the information from the former employer to the new employer or to an individual plan. Porting of the plan, for example, includes adjusting individual user information in the data store 512 to link the product data 542 associated with the particular individual user data 546 to the new employer data 550. Further, the new employer data 550 may be adjusted to identify pre-existing claims data 538 or prescription data 540. The pre-existing claims data 538 or prescription data 540, for example, may be mined to identify ongoing expenses corresponding to the employee's selected plan.

In some implementations, the dashboard system 604 provides information regarding the employer update (638) to the industry participant system 608. For example, the industry participant may be alerted that the plan has been shifted to the employer system 602. Furthermore, in some embodiments, any adjustments to the selected plan, such as a premium adjustment based upon a regional relocation of the employee, may be provided to the industry participant system 608. Although, as illustrated, it appears that the dashboard system 604 is pushing information to the industry participant system 608, in some embodiments, the industry participant system 608 may establish a communication link with the dashboard system 604, such as on a periodic basis, to retrieve updated information regarding plan selections. Further, in some implementations, the industry participant may access information regarding present plans via the enrollment information pane 404 of the dashboard 400, 460, or 480 as described in relation to FIGS. 4A through 4C.

In some implementations, the dashboard system 604 provides information regarding the individual user's plan election (640) to the employer system 602. For example, if the individual user has an employee contribution amount, the dashboard system 604 may provide the employer system 602 with information required to update the payroll system to make the necessary deductions. Conversely, if the individual user selected a plan that costs less than the employer's defined contribution, the dashboard system 604 may provide the employer system 602 with information regarding a surplus remainder in defined contribution.

Although described in relation to an insurance plan, in some implementations, the individual user is provided the opportunity to port one or more voluntary products, depending upon whether the voluntary products are covered under the new employer. For example, the individual user, in addition to porting a medical plan, may port a dental plan. In other implementations, the certain steps of the method 600 may be performed in a different order. For example, in some implementations, the individual user's contribution may be determined (630) prior to presenting the plan selection interface (626). One or more steps of the method 600, in further implementations, may be removed or added.

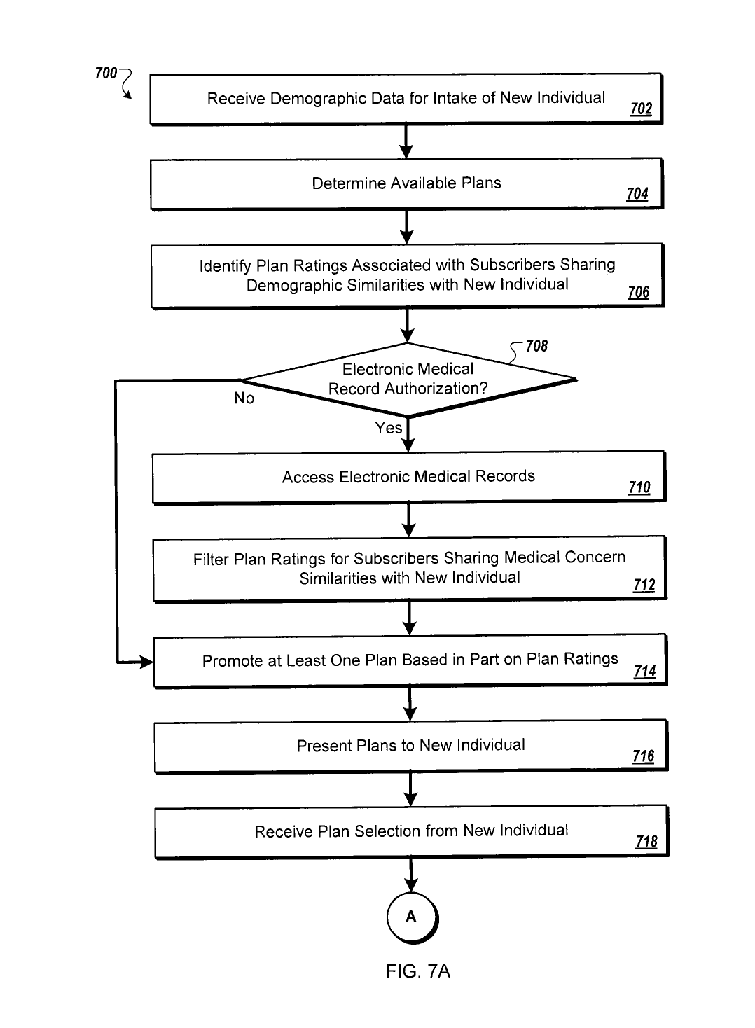

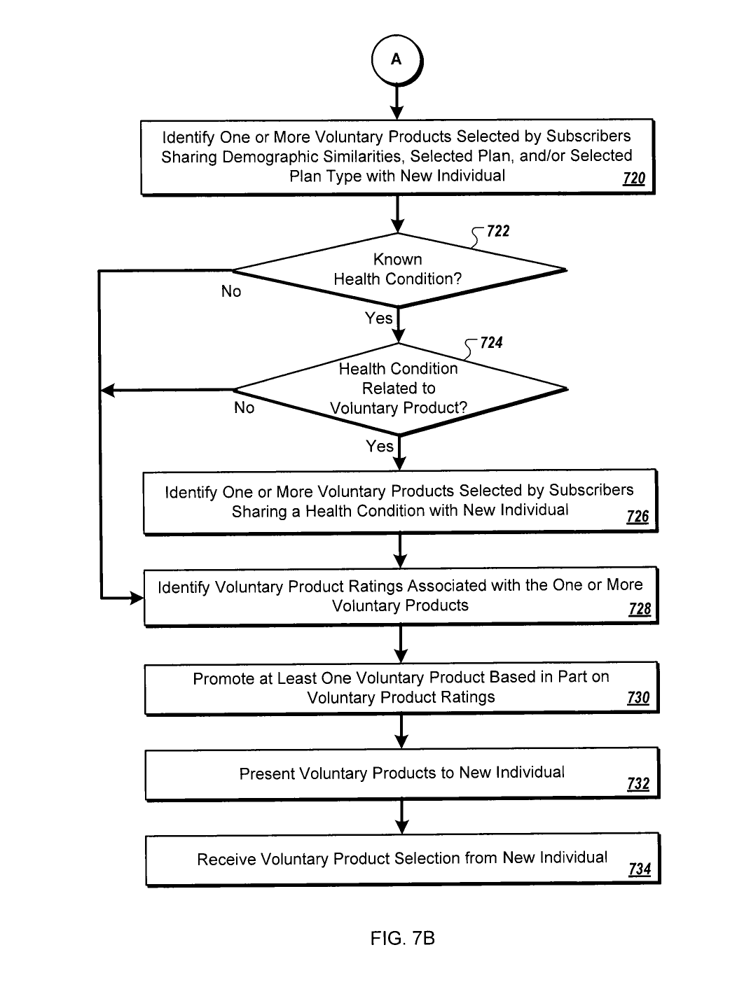

FIGS. 7A and 7B illustrate a flow chart of an example method 700 for presenting a potential individual user with plan and voluntary product information based in part on ratings data collected from other individual users in a dashboard system. The ratings and review engine 528 of FIG. 5A may collect and organize ratings data 548 and reviews data 555 used by the recommendation engine 526 to present recommended primary products and/or voluntary products to an individual user 508. The information regarding products, for example, may be presented to the individual user in the “my health plan” tab 116b of the dashboard 100 of FIG. 1. For example, the method 700 may be launched upon selection, by the individual user, of the “health plan” navigational control 114a.

In some implementations, the method 700 begins with receiving demographic data for intake of a new individual in a dashboard system (702). The demographic data, for example, may include individual user data 546 illustrated in FIG. 5A such as, in some examples, age, gender, geographic region, family structure (e.g., spouse or domestic partner, number of children, etc.), and career category. At least a portion of the demographic data may be entered into the dashboard system by an entity 506 the new individual user 508 has an affiliation with, for example as part of the human resource intake process. Further, in some embodiments, the individual user 508 may enter a portion of the demographic information, for example during initial registration as a new individual user of the dashboard system 502.

In some implementations, available products are determined (704). The available products, for example, may include products pre-selected by an employer of the individual user. In another example, the available products may be identified based upon a demographic region of the individual user. In further examples, the available products may be limited to plans fitting criteria supplied by the individual user, such as products within a budget designated by the individual user or products including a number of desired features identified by the individual user.

In some implementations, product ratings associated with at least one of the available products, submitted by users sharing demographic similarities with the new individual user, are identified (706). User demographic data associated with product ratings may be cross-referenced against the new individual user's demographic data to identify one or more similarities. The similarities may include, in some examples, an age range, geographic region, gender, family status, and/or ethnicity. In other example, any ratings provided by individual users having a threshold demographic similarity (e.g., 15%, 20%, or 30% similar, etc.) with the new individual user are identified. Rather than or in addition to correlating stored demographic information regarding individual users, demographic information may be derived from text submitted in a review corresponding to a rating. For example, in identifying ratings submitted by parents of newborns, the text of a review may be culled for terms such as “infant”, “newborn”, or “baby.”

In some implementations, if the new individual user authorizes electronic medical record access (708), the individual user's electronic medical records are accessed (710). For example, as described in relation to FIG. 5A, the dashboard system 502 may access medical records 510 from an external repository. Depending upon local privacy law and/or individual user privacy settings, a portion of the data may be available for access by the dashboard system 502 to enrich recommendations.

In some implementations, the identified product ratings are filtered to identify ratings associated with individual users sharing medical concern similarities with the new individual user (712). The medical concerns, in one example, may be identified within electronic medical record data of the existing individual users. In another example, the medical concerns may be derived (or implied) from prescription data 540 and/or claims data 538. Further, some medical concerns may have been supplied by individual users, for example upon registering with the dashboard system. In one example, chronic medical issues (e.g., diabetes, asthma, arthritis, etc.) may be identified within the electronic medical record data and compared to medical concerns of individual users who submitted the identified product ratings. In another example, preferred treatment methods (e.g., chiropractic, acupuncture, physical therapy, etc.) derived from the electronic medical records of the new individual user may be compared to preferred treatment methods of the individual users who submitted the identified product ratings. The recommendation engine 526 illustrated in FIG. 5A, for example, may review ratings to identify individual users sharing medical concerns with the new individual user. Rather than or in addition to correlating stored medical concern information regarding individual users, medical concern “buzz words” may be identified within text submitted in a review corresponding to a rating. For example, in identifying ratings submitted by those suffering from osteoporosis, the reviews may be culled for the term “osteoporosis” as well as, in some examples, “bone density”, “bone mineral density”, BMD, SIOP, “preosteoporosis”, and/or “osteopenia.”

Rather than filtering the previously identified product ratings to identify product ratings associated with individual users sharing medical concerns with the new individual user, in other implementations, product ratings associated with at least one of the available products, submitted by individual users sharing medical concern similarities with the new individual user, may be identified. For example, if the new individual user has a rare medical concern, limiting the scope to ratings which also share demographic similarities with the new individual user may prove to be too limiting. The recommendation engine 526, in some embodiments, may expand the review scope when limiting to only those ratings sharing demographic similarities results in less than a threshold number of results.

In some implementations, at least one of the available products is promoted based in part upon the identified product ratings (714). For example, the recommendation engine 526 of FIG. 5A may aggregate identified ratings to determine a highest rated product in light of individual users most similar to the new individual user. Additionally, the remaining products may be ranked according to relative ratings. The promotion or ranking, for example, may effect presentation of the information to the new individual user.

In some implementations, the available products are presented to the new individual (716). The products, for example, may be arranged in order from top to bottom of the page in relative ratings rank. In another example, the products may be arranged in order from left to right across the page in relative ratings rank. The product with the highest adjusted rating, in a third example, may be surrounded by a colorful box or otherwise highlighted in relation to the additional available products. The adjusted ratings value(s), in one example, may be presented to the new individual user. Furthermore, one or more reviews selected in relation to the ratings may be presented or made available to the new individual user.

In some implementations, a product selection is received from the new individual user (718). The new individual user, upon reviewing the available plans, may select a product. For example, the new individual user may click on the product description, call a telephone number associated with the dashboard system and environment and make an oral selection, or mail in a selection (e.g., via paperwork filled out and filed by the human resource department of the new individual user's employer).

Although described in relation to a new individual user, in some implementations, a similar method may be used to present a current individual user with information for changing products. An individual user may change a product, for example, due to a change in employment or a change in family status. The method 700, in this manner, may be executed upon selection of the “compare to available coverage” control 138a of the dashboard 100, described in relation to FIG. 1.

FIG. 7B presents an additional section of the method 700 pertaining to marketing voluntary products to a new individual user in addition to the selected primary product. A set of most applicable voluntary products to the lifestyle and health concerns of the new individual user, for example, may be identified based in part upon reviewing selections made by other individual users identified as sharing similarities with the new individual user. The steps illustrated in FIG. 7B, in some embodiments, are performed along with health insurance plan election (e.g., prior to confirmation of election or while the new individual user is reviewing plan options). In other embodiments, the steps illustrated in FIG. 7B are performed after the new individual has finalized a health insurance plan election (e.g., become a subscriber). The order and scope of the steps illustrated in FIG. 7B may alter depending upon the use of the promotion and marketing of voluntary products in the dashboard system and environment.

Turning to FIG. 7B, in some implementations, one or more voluntary products selected by individual users sharing similarity in demographic(s), similarity in selected primary product, and/or similarity in selected product type with the new individual user are identified (720). For example, based upon the primary product and/or product type, the primary product may be lacking a desirable feature that may be provided by a voluntary product, such as vision insurance and/or dental insurance. The desirability of these features may vary based upon demographics, such as age range or family composition. For example, the parent of a child within the age range of the need for braces may be more likely to want a dental insurance plan. In some implementations, individual user demographic data associated with voluntary product elections are cross-referenced against the new individual user demographic data to identify one or more similarities. The similarities may include, in some examples, an age range, geographic region, gender, family status, and/or ethnicity. In other example, any ratings provided by individual users having a threshold demographic similarity (e.g., 15%, 20%, or 30% similar, etc.) with the new individual user are identified. The recommendation engine 526 described in relation to FIG. 5A, for example, may identify voluntary one or more products.

In some implementations, if the new individual user or a family member of the new individual user has a known health condition (722) that is determined to be related to a voluntary product (724), one or more voluntary products selected by individual users sharing the health condition with the new individual user (or family member thereof) are identified (726). For example, if the new individual user has gum disease, a dental plan selected by those individual users with gum disease may be identified.

In some implementations, voluntary product ratings associated with the one or more voluntary products are identified (728). The recommendation engine 526 illustrated in FIG. 5A, for example, may access product ratings for the one or more voluntary products. Furthermore, in some embodiments, the product ratings may be filtered to include only those submitted by individual users who share demographics, primary product type, or primary product selection with the new individual user.

In some implementations, at least one of the voluntary products is promoted based in part upon the identified voluntary product ratings (730). In one example, the recommendation engine 526 of FIG. 5A may identify the most commonly selected voluntary product by individual users sharing demographics, primary product type, or primary product selection with the new individual user. In another example, the recommendation engine 526 of FIG. 5A may aggregate identified ratings to determine a highest rated voluntary product in light of individual users most similar to the new individual user. Additionally, the remaining voluntary products may be ranked according to relative ratings and/or relative popularity.

In some implementations, the voluntary products are grouped by product type prior to promotion. For example, the recommendation engine 526 of FIG. 5A may compare various available dental insurance plans separately from various available vision insurance plans.

One or more voluntary product types, in some implementations, may be offered by the employer of the new individual user as part of a benefits package. For example, the new individual user may receive partial or full contribution towards a dental insurance plan premium. In this case, the voluntary product type(s) offered by the employer may be promoted in relation to other voluntary products available to the new individual user. In one example, information regarding employer contribution may be highlighted in relation to a particular voluntary product, such as pet insurance. In this manner, the employer may market the benefits offering to employees through the dashboard system and environment \.

In some implementations, the recommended voluntary products are presented to the new individual user (732). The voluntary products, for example, may be grouped according to product type (e.g., disability insurance, pet insurance, dental insurance, vision insurance, etc.), with a particular product within each group highlighted or promoted in relation to additional voluntary product options, if applicable. The adjusted ratings value(s), in one example, may be presented to the new individual user. Furthermore, one or more reviews selected in relation to the product ratings may be presented or made available to the new individual user.

In some implementations, a voluntary product selection is received from the new individual user (734). The new individual user, upon reviewing the available voluntary products, may select a voluntary product. In some examples, the new individual user may click on the voluntary product, call a telephone number associated with the dashboard system and environment and make an oral selection, or mail in a selection (e.g., via paperwork filled out and filed by the human resource department of the new individual user's employer).

In other implementations, the certain steps of the method 700 may be performed in a different order. For example, in some implementations, the product ratings associated with individual users sharing medical concern similarities with the new individual user (712) may be identified prior to filtering for product ratings associated with individual users sharing demographic similarities with the new individual user (706). One or more steps of the method 600, in further implementations, may be removed or added.

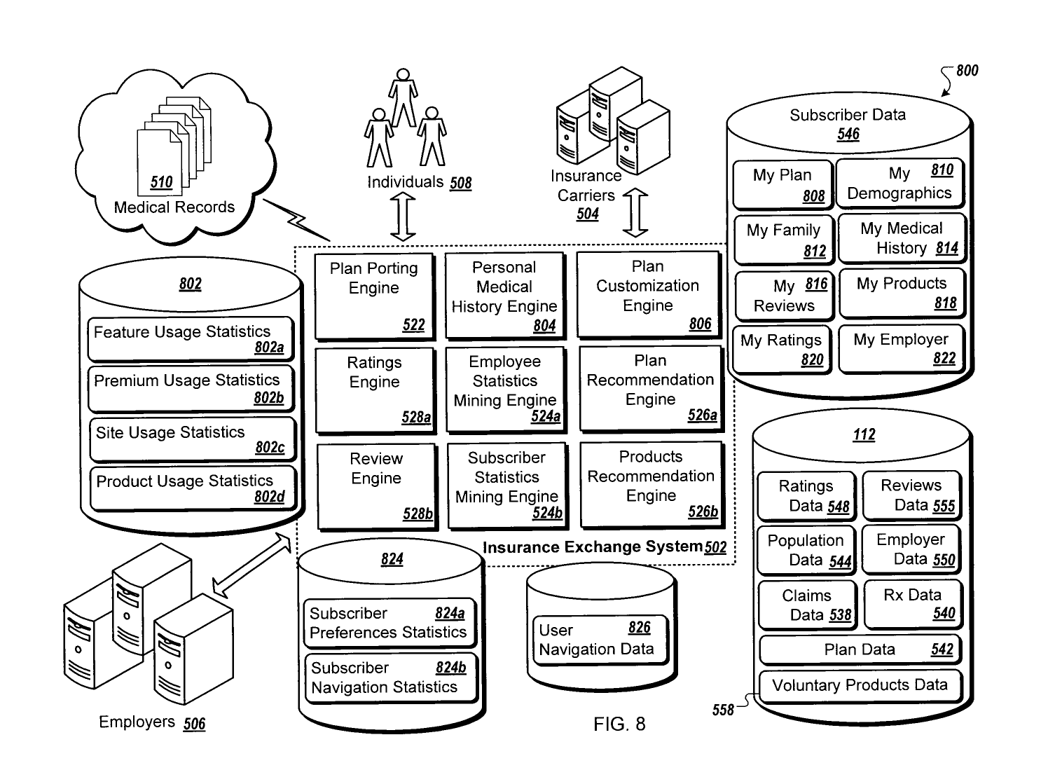

FIG. 8 is a block diagram of an example environment 800 for personalizing the dashboard system 502 experience for both entities 506 and individual users 508. The environment 800, as compared to the environment 500 of FIG. 5A, includes enhanced individual user data 546 identifying various individual user information tracked by the dashboard system 502, employee usage statistics 802 derived by an employee statistics mining engine 524a and individual user statistics mining engine 524b for providing entities 506 with insight towards employee usage of the dashboard system 502, and a plan customization engine 806 to support customization of employer offerings based in part upon the employee usage statistics 802 as well as, in some circumstances, more general individual user preferences derived by a individual user statistics mining engine 524b. The statistics information, for example, may be presented to dashboard system users (e.g., industry participants, individual user, and entities) in dashboard form via a dashboard engine 535. The dashboard engine 535, for example, may present the information illustrated in FIGS. 1 through 4.

The environment 800, in some implementations, uses enhanced individual user data 546 to provide greater features and flexibility to individual users 508. For example, individual user data 546 is used by a personal medical history engine 804 to combine data from electronic medical records 510 with individual user claims data 538 and/or individual user prescription data 540 to present individual users 508 with a personalized medical history portal graphically illustrating individual user medical history data 814. In another example, the plan porting engine 522 can port individual user acquisition profile data “my plan” 808 from a prior employer to a present employer as present employer data 822 or to an individual plan. The individual user data 546 lends to statistical analysis provided to individual users, such as comparisons of health issues (e.g., “compare your averages for your age, gender, and race” control 124 of the individual user dashboard 100 of FIG. 1) or risk scores (e.g., “compare to averages for your age, gender, and race” control 132 of the individual user dashboard 100). Furthermore, the individual user data 546 lends to statistics available via the “employees and medical histories” information pane 204 and/or the “risk score” information pane 206 of the dashboard 200 of FIG. 2. The “group and individual data” information pane 302 of the dashboard 300 of FIG. 3, in another example, provides access to various individual user data 546. Furthermore, the “customer ratings and market demographic data” pane 408 of the dashboards 400, 460, and 480 of FIGS. 4A through 4C includes access to statistics derived from the individual user data 546.

A ratings engine 528a enables individual users 508 to submit ratings regarding primary products and/or voluntary products, while a reviews engine 528b enables individual users 508 to submit reviews regarding the same. The resultant reviews data 555 and ratings data 548 is accessed by both a plan recommendation engine 526a and a products recommendation engine 526b to enhance individual user selection of primary products and voluntary products within the dashboard system 502. For example, the plan recommendation engine 526a can customize primary product option presentation for an individual user based upon product ratings and reviews of other individual users 508 similar to the individual user, as described in relation to FIG. 7A, while a products recommendation engine 526b can customize voluntary products option presentation for an individual user based upon selections, ratings, and reviews of other similar individual users 508, as described in relation to FIG. 7B. Furthermore, statistical analysis of the product ratings, derived by the individual user statistics mining engine 524b, lends data to the dashboard 100 of FIG. 1 (e.g., via the “other carriers by user rating” control 136), the dashboard 200 of FIG. 2 (e.g., via the “ratings of current plans relative to peers” control 240), and the dashboard 300 of FIG. 3 (e.g., via the “plan ratings by sector, region” control 338). Furthermore, the ratings data statistics are important to the industry participants 504, as demonstrated by the “customer ratings compared to peers” control 446 of dashboards 400, 460, and 480.

The interactions of individual users 508 with the dashboard system 502 are logged as various individual user data 546, such as user acquisition profile “my plan” 808 (e.g., linking to product data 542), user demographics 810 (e.g., categorized in part by population data 544), user family data 812 (e.g., linking a present individual user with additional individual users 508 of the dashboard system 502), user medical history 814 (e.g., including information derived from electronic medical records 510, claims data 538, and/or prescription data 540), user reviews 816 (e.g., linking to reviews data 555), user ratings 810 (e.g., linking to ratings data 548), user products 818 (e.g., linking to one or more voluntary products 558), and user's employer 822 (e.g., identifying one of the employers 550).

The employee statistics mining engine 524a mines user data 546 to identify trends in individual user usage of the dashboard system 502. Feature usage statistics 802a, derived by the employee statistics mining engine 524a, maps claims data 538 of employees of a particular entity 506 to features and/or feature subsets of plans to identify “hot spots” in plan use. For example, employees of a particular entity 506 may make great use of health club membership reimbursement but rarely take advantage of mail order pharmaceuticals. Similarly, the employee statistics mining engine 524a may generate product usage statistics identifying most popular products or product types. In this manner, an entity 506 may determine which voluntary products to offer as partially or fully funded employee benefits. Premium usage statistics 802b, derived by the employee statistics mining engine 524a, track claims data 538 in comparison to premium payments made by the entity 506 to demonstrate spikes and lulls in employee medical costs over time. Site usage statistics 802c, derived by the employee statistics mining engine 524a, identifies site features commonly utilized by individual users. For example, an entity 506 may wish to determine whether to purchase premium site usage with personal medical history portal capability (e.g., provided by the personal medical history engine 804).

In some implementations, the plan customization engine 806 generates customized offerings for employer benefits based upon trends derived from the employee statistics 802. For example, the plan customization engine 806 may promote the most popular features and products, as identified by the feature usage statistics 802a and product usage statistics 802d, as best options. In another example, the plan customization engine 806 may recommend downgrading to a less expensive plan as a replacement for a more expensive plan should the plan customization engine 806 determine that one or more features of the more expensive plan are rarely if ever used by the employees of a particular entity 506 (e.g., via the feature usage statistics 802a). Additionally, site features may be promoted based upon anticipated use, for example by demonstrating that employees of similar entities take advantage of the personal medical history portal provided by the personal medical history engine 804.

The employee statistics mining engine 524a, in some implementations, mines individual user data, such as demographics data 810, medical history data 814, claims data 538, and prescription data 540 to analyze risk factors in individual employees and/or groupings of employees. The risk factors, for example, may contribute to the risk scores discussed in relation to risk data 552, risk assessment data 556, and risk analysis engines 516, 520 of FIG. 5A. The entities 506 may contribute additional data for analysis, such as absenteeism data, health screening data (e.g., obtained through employer sponsored health events), and/or data regarding employee participation in employer-sponsored wellness programs. Through analysis of health and wellness data associated with employees, employers may gain insight into potential avenues (e.g., employer sponsored programs, voluntary products, workplace improvements, etc.) for improvement in the health and well-being of the employee base. The entities 506 may further provide salary information for inclusion in the analysis to contribute to overall cost analysis associated with the risk factors (e.g., absenteeism as well as medical claims and prescription costs). The analysis may be tracked over time and/or compared to peers of an individual employer to provide entities 506 with insight into risk reduction achieved through implementation of improvements (e.g., employer sponsored wellness programs, etc.).

The user statistics mining engine 524b, in some implementations, mines individual user data 546 to identify trends in individual user usage of the dashboard system 502. Industry participants 504, for example, may review user preferences statistics 824a, generated by the user statistics mining engine 524b, to customize plan offerings based upon preferred features. In some embodiments, the plan customization engine 806 may recommend new or updated plan offerings to the industry participants 504 based upon user preferences statistics 824a. For example, as described above in relation to feature usage statistics 802a, general user feature usage statistics may map claims data 538 of individual users 508 to features and/or feature subsets of products to identify “hot spots” in product use. This information, for example, may be presented to personnel of the dashboard system within the market data tab 314d of the dashboard 300 of FIG. 3.

The user statistics mining engine 524b, in some implementations, mines user navigation data 826 to identify usage trends of a web portal feature of the dashboard system 502. The dashboard system 502, for example, may modify navigation paths of the web portal based upon review of user navigation data 82b to make the web portal as user-friendly as possible. Furthermore, industry participants 504 may review user navigation statistics 824b to identify commonly reviewed product information to identify most important features to users in making product selections.

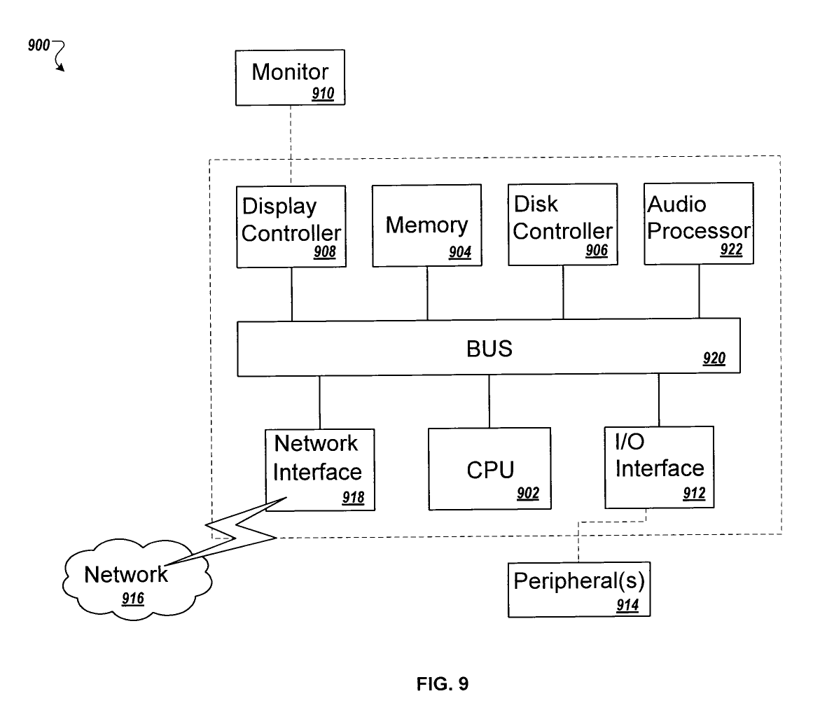

FIG. 9 illustrates an example processing system 900, and illustrates example hardware found in a controller or computing system (such as a personal computer, i.e., a laptop or desktop computer, which can embody a workstation, server, personal computer, or other computing device according to this disclosure) for implementing and/or executing the processes, algorithms and/or methods described in this disclosure. The processing system 900 in accordance with this disclosure can be implemented in one or more the components shown in FIG. 1. One or more processing systems can be provided to collectively and/or cooperatively implement the processes and algorithms discussed herein.

As shown in FIG. 9, the processing system 900 in accordance with this disclosure can be implemented using a microprocessor 902 or its equivalent, such as a central processing unit (CPU) and/or at least one application specific processor ASP (not shown). The microprocessor 902 is a circuit that utilizes a computer readable storage medium 904, such as a memory circuit (e.g., ROM, EPROM, EEPROM, flash memory, static memory, DRAM, SDRAM, and their equivalents), configured to control the microprocessor 902 to perform and/or control the processes and systems of this disclosure. Other storage mediums can be controlled via a controller, such as a disk controller 906, which can control a hard disk drive or optical disk drive.

The microprocessor 902 or aspects thereof, in alternate implementations, can include or exclusively include a logic device for augmenting or fully implementing this disclosure. Such a logic device includes, but is not limited to, an application-specific integrated circuit (ASIC), a field programmable gate array (FPGA), a generic-array of logic (GAL), and their equivalents. The microprocessor 902 can be a separate device or a single processing mechanism. Further, this disclosure can benefit from parallel processing capabilities of a multi-cored CPU.

In another aspect, results of processing in accordance with this disclosure can be displayed via a display controller 908 to a display device (e.g., monitor) 910. The display controller 908 preferably includes at least one graphic processing unit, which can be provided by a number of graphics processing cores, for improved computational efficiency. Additionally, an I/O (input/output) interface 912 is provided for inputting signals and/or data from microphones, speakers, cameras, a mouse, a keyboard, a touch-based display or pad interface, etc., which can be connected to the I/O interface as a peripheral 914. For example, a keyboard or a pointing device for controlling parameters of the various processes and algorithms of this disclosure can be connected to the I/O interface 912 to provide additional functionality and configuration options, or control display characteristics. An audio processor 922 may be used to process signals obtained from I/O devices such as a microphone, or to generate signals to I/O devices such as a speaker. Moreover, the display device 910 can be provided with a touch-sensitive interface for providing a command/instruction interface.

The above-noted components can be coupled to a network 916, such as the Internet or a local intranet, via a network interface 918 for the transmission or reception of data, including controllable parameters. A central BUS 920 is provided to connect the above hardware components together and provides at least one path for digital communication there between.

One or more processors can be utilized to implement any functions and/or algorithms described herein, unless explicitly stated otherwise. Additionally, any functions and/or algorithms described herein, unless explicitly stated otherwise, can be performed upon one or more virtual processors, for example on one or more physical computing systems such as a computer farm or a cloud drive.

Reference has been made to flowchart illustrations and block diagrams of methods, systems and computer program products according to implementations of this disclosure. Aspects thereof are implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

A number of implementations have been described. Nevertheless, it will be understood that various modifications may be made without departing from the spirit and scope of this disclosure. For example, preferable results may be achieved if the steps of the disclosed techniques were performed in a different sequence, if components in the disclosed systems were combined in a different manner, or if the components were replaced or supplemented by other components. The functions, processes and algorithms described herein may be performed in hardware or software executed by hardware, including computer processors and/or programmable circuits configured to execute program code and/or computer instructions to execute the functions, processes and algorithms described herein. Additionally, some implementations may be performed on modules or hardware not identical to those described. Accordingly, other implementations are within the scope that may be claimed.

1.-7. (canceled)

8. A dashboard interface system, comprising:
a computer storage system comprising one or more non-transitory computer readable storage mediums configured to maintain
product data related to a plurality of industry participant products,
individual user data related to a plurality of individual users, and
acquisition profile data related to a plurality of acquisitions of products by at least a subset of the plurality of individual users; and
a graphical user interface system comprising
a non-transitory computer readable medium having instructions stored thereon, and
one or more processors executing upon at least one computing device;
wherein the instructions, when executed by at least one of the one or more processors of the graphical user interface system, cause the graphical user interface system to
receive, from a first industry participant server system of a plurality of industry participant server systems via a network, a request for information pertaining to one or more products of the plurality of industry participant products, wherein each product of the one or more industry participant products is provided by the industry participant of the first industry participant server system;
determine, from a plurality of industry participants associated with the plurality of industry participant server systems, a plurality of peer industry participants to the industry participant of the first industry participant server system, wherein determining the plurality of peer industry participants comprises identifying, from at least one of the product data and the acquisition profile data, at least one of
a) industry participants having an aggregate user acquisition value within a threshold percentage of a total user acquisition value of the industry participant of the first industry participant server system,
b) industry participants sharing one or more geographic markets with the industry participant of the first industry participant server system,
c) industry participants sharing one or more employment markets with the industry participant of the first industry participant server system, and
d) industry participants having an aggregate user remittance value within a threshold value of an aggregate user remittance value of the industry participant of the first industry participant server system;
access, from the computer storage system, the product data and the individual user data related to the plurality of peer industry participants and the industry participant of the first industry participant server system;
determine, based at least in part upon the product data and the individual user data for i) each peer industry participant of the plurality of peer industry participants and ii) the industry participant of the first industry participant server system, a plurality of positive acquisition values, wherein the plurality of positive acquisition values include acquisition by month and acquisition by product type;
prepare, for presentation to a user of the first industry participant system, a dashboard interface including
a visual comparison of acquisition by month of the industry participant of the first industry participant server system to the respective acquisition by month of each industry participant of the plurality of peer industry participants, and
a visual comparison of acquisition by product type of the industry participant of the first industry participant server system to the respective acquisition by product type of each peer industry participant of the plurality of peer industry participants,
wherein the plurality of peer industry participants are identified anonymously within the dashboard interface; and
provide, to the first industry participant system via the network, the dashboard interface.

9. The system of claim 8, wherein the instructions, when executed by at least one of the one or more processors of the graphical user interface system, cause the graphical user interface system to:
coordinate, with each individual user of a plurality of individual users via the network, a respective acquisition profile; and
store, within the acquisition profile data of the computer storage system, respective acquisition profile data associated with each acquisition profile of the plurality of acquisition profiles, wherein the respective acquisition profile data comprises a respective acquisition date and a respective product type.

10. The system of claim 9, wherein coordinating the plurality of acquisition profiles comprises, for each individual user of the plurality of individual users:
preparing, for presentation on a respective user computer system, a graphical user interface comprising product information of each product of a plurality of products, wherein each product is further associated with a respective industry participant of the plurality of industry participants affiliated with the plurality of industry participant server systems; and
receiving a respective product selection identifying a first product of the plurality of products, wherein storing the respective acquisition profile data comprises storing the respective product type of the selected product.

11. The system of claim 10, wherein preparing the graphical user interface comprises associating, with each product of the plurality of products, respective ratings information.

12. The system of claim 11, wherein the instructions, when executed by at least one of the one or more processors of the graphical user interface system, cause the graphical user interface system to:
receive, from each individual user of a plurality of individual users having acquired at least one product, ratings information associated with a respective acquisition profile; and
store, within the product data of the computer storage system, respective ratings information associated with the respective acquisition profile; wherein
preparing the graphical user interface comprises promoting, based upon the respective ratings information, at least one product of the plurality of products.

13. The system of claim 12, wherein promoting the at least one product comprises identifying ratings information associated with one or more individual users sharing at least one similarity with the respective user, wherein the at least one similarity comprises a similarity in medical history information.

14. The system of claim 13, wherein:
the industry participants comprise at least one of insurance carriers and self-insured employers; and
the instructions, when executed by at least one of the one or more processors of the graphical user interface system, cause the graphical user interface system to derive, from claims data associated with a plurality of claims submitted to the dashboard interface system regarding the one or more individual users sharing at least one similarity with the respective user, a respective medical condition of each individual user of the one or more individual users sharing at least one similarity with the respective user.

15. The system of claim 10, wherein preparing the graphical user interface comprises
identifying, based upon the respective individual user of the plurality of individual users, an affiliated entity;
accessing one or more products of a plurality of offered products promoted by the entity on behalf of affiliated individual users; and
limiting the graphical user interface to the one or more products promoted by the entity.

16.-19. (canceled)

20. A dashboard interface system, comprising:
a non-transitory computer readable medium having instructions stored thereon; and
one or more processors executing upon at least one computing device;
wherein the instructions, when executed by at least one of the one or more processors of the dashboard interface system, cause the dashboard interface system to
prepare, for presentation to a user of a first industry participant computing system of a plurality of industry participant computing systems, a first dashboard interface comprising overview information arranged in a series of information panes, wherein a first information pane of the series of information panes includes product acquisition information, and a second information pane of the series of information panes includes product-related interactions and activities information;
provide, via a network to the first industry participant computing system, the first dashboard interface;
receive, via the network responsive to selection of a control within the first dashboard interface, a request for information pertaining to one or more products of a plurality of industry participant products, wherein each product of the one or more products is provided by a requesting industry participant associated with the request;
determine, in real time from a plurality of industry participants associated with the plurality of industry participant computing systems, a plurality of peer industry participants to the requesting industry participant, wherein determining the plurality of peer industry participants comprises at least one of
a) an industry participant providing administrative services on behalf of the requesting industry participant, and
b) an entity participant sharing one or more of an employment sector, a geographic location, a size, and a maturity with the requesting participant;
access, from a computer storage system comprising one or more non-transitory computer readable storage mediums,
requestor product data related to the one or more products, and
comparison product data related to a plurality of similar products, wherein each similar product of the plurality of similar products is offered by a particular peer industry participant of the plurality of peer industry participants;
determine, based at least in part upon the requestor product data and the comparison product data, a plurality of product acquisition values;
prepare, for presentation to a user of the first industry participant computing system, a second dashboard interface including a visual comparison of acquisition by product type of the requesting industry participant to the respective acquisition by product type of each peer industry participant of the plurality of peer industry participants, wherein the plurality of peer industry participants are identified anonymously within the dashboard interface; and
provide, to the first industry participant system via the network, the second dashboard interface.

21. The system of claim 20, wherein determining the plurality of peer industry participants comprises filtering the plurality of peer industry participants by product types offered to identify a subset of the plurality of peer industry participants sharing one or more product types with the requesting industry participant.

22. The system of claim 20, wherein preparing the first dashboard interface comprises:
determining, for presentation in the second information pane, subscription usage metrics related to at least a first product of the one or more products; and
grouping the subscription usage metrics by at least one of business sector, geography, timeframe, and product type.

23. The system of claim 22, wherein determining the subscription usage metrics comprises filtering a plurality of claims records filed through a dashboard environment, wherein the dashboard environment comprises the dashboard interface system.

24. The system of claim 22, wherein determining the subscription usage metrics comprises filtering a plurality of claims records uploaded to a dashboard environment by the requesting industry participant, wherein the dashboard environment comprises the dashboard interface system.

25. The system of claim 20, wherein preparing the first dashboard interface comprises including, within the second information pane, an interaction control configured, upon selection, to trigger an internal algorithm designed for interoperation with the dashboard interface system, wherein
the internal algorithm, when executed, causes the first industry participant system to prepare an interaction information presentation, within the first dashboard interface, comprising
aggregate interaction data related to a plurality of individual users, wherein each individual user of the plurality of individual users acquired at least one product from the requesting industry participant, and
aggregate transaction data related to products acquired by the plurality of individual users, wherein the requesting industry participant maintains respective transaction data for each user of the plurality of users internally for private review.

26. The system of claim 25, wherein the instructions, when executed, cause the processor to, prior to providing the first dashboard interface, provide, to the first industry participant computing system via the network, a software executable comprising the internal algorithm.

27. The system of claim 22, wherein preparing the first dashboard interface comprises preparing, for presentation in a third information pane of the series of information panes, aggregate demographic information related to a plurality of individual users, wherein each individual user of the plurality of individual users acquired at least one product from the requesting industry participant.

28. The system of claim 27, wherein the demographic information comprises an average risk score.

29. The system of claim 28, wherein determining the average risk score comprises analyzing historic interaction data related to the plurality of individual users.

30. The system of claim 20, wherein preparing the first dashboard interface comprises identifying individual aspects of overview information for inclusion within the first dashboard interface based in part upon a user authorization level of the user.

31. The system of claim 20, where product type comprises one or more of a deductible level, a copay level, and inclusion of a particular premium feature.
